(19) United States
(12) Patent Application Publication
(10) Pub. No.: US 2026/0212419 A1
(43) Pub. Date: Jul. 23, 2026

(54) RECOMMENDATION ENGINE AND SYSTEMS AND METHODS THEREFOR

(71) Applicant: BUYPROPERLY LIMITED, Toronto (CA)

(72) Inventors: Khushboo JHA, Toronto (CA); Vivek VINOD, Toronto (CA); Deepa FRANCIS, Toronto (CA)

(21) Appl. No.: 19/458,531

(22) Filed: Jan. 23, 2026

Related U.S. Application Data
(60) Provisional application No. 63/748,677, filed on Jan. 23, 2025.

(51) Int. Cl. G06Q 40/06

(52) U.S. Cl. CPC G06Q 40/062

(57) ABSTRACT

A system and computer-implemented method of recommending transactions are provided. The computer-implemented method comprises obtaining deal data for a plurality of deals, normalizing the investor data into investor feature values, normalizing the deal data into deal feature value, populating the investor feature values and the deal feature values into a database, training a machine learning model with the investor feature values and the deal feature values, determine an overall investor score for each investor in the plurality of investors, determine an overall deal score for each deal in the plurality of deals, and determine a plurality of recommended deals for each investor based on the overall investor scores and the overall deal scores, and sending a notification message to each investor once the recommended deals have been determined for that investor. The investor and deal constraints are factored into the investor feature values during normalization.

### CROSS-REFERENCE

This application claims the benefit of U.S. Patent Application No. 63/748,677 filed on Jan. 23, 2025, its contents of which are herein incorporated by reference in its entirety.

### FIELD

The present disclosure generally relates to artificial intelligence, and in particular to a recommendation engine and systems and methods therefor.

### Introduction

Public market recommendation engines provide recommendations and relative ease of purchase of public market equities. Such engines may request information from potential investors to build an investor profile to match investment strategies. E.g., a profile that can tolerate a higher risk would be recommended stocks that have higher risk with the possibility of a higher return. Conversely, a lower risk tolerance would lead to a recommendation for “safer” investments. These types of investment are typically for public market stocks or shares.

Private-market investment platforms increasingly rely on automated or semi-automated decision support systems to match investors with investment opportunities such as private equity, private credit, real estate, venture capital, and other alternative assets. Unlike public-market securities, private-market transactions are subject to strict regulatory, jurisdictional, accreditation, suitability, and concentration constraints, which must be satisfied before an investment opportunity may be presented to a particular investor. Failure to enforce such constraints prior to recommendation or execution can result in regulatory violations, unsuitable investment exposure, and operational risk.

### SUMMARY

In accordance with an aspect, there is provided a system for recommending transactions. The system comprises at least one processor and a memory storing instructions which when executed by the at least one processor cause the at least one processor to obtain client data, obtain transaction data, determine a client risk score for each client in the client data, determine a transaction risk score for each transaction in the transaction data, and match at least two client risk scores to at least one transaction.

In accordance with another aspect, there is provided a method of recommending transactions. The method comprises obtaining client data, obtaining transaction data, determining a client risk score for each client in the client data, determining a transaction risk score for each transaction in the transaction data, and matching at least two client risk scores to at least one transaction.

In accordance with another aspect of the present disclosure, there is provided a computer-implemented method for generating compliant and explainable recommendations of private-market investment opportunities, the method comprising receiving investor data and deal data; constructing investor eligibility profiles and deal eligibility rule sheets; filtering investment opportunities prior to scoring to produce an eligible-deal set; generating multiple relevance scores for each eligible investment opportunity using heterogeneous recommendation models; normalizing and fusing the relevance scores using an adaptive neuro-fuzzy inference system; ranking the eligible investment opportunities; and presenting a subset of top-ranked investment opportunities together with rule-based explanations. In some embodiments, the method further comprises collecting explicit and implicit investor outcome data and periodically retraining one or more of the recommendation models using the collected data.

In accordance with another aspect of the present disclosure, there is provided a system for recommending deals. The system comprises a machine learning data model, a database for storing feature values used by the machine learning data model, at least one processor and a memory storing instructions which when executed by the at the least one processor cause the at least one processor to obtain investor data for a plurality of investors, obtain deal data for a plurality of deals, normalize the investor data into investor feature values, normalize the deal data into deal feature value, populate the investor feature values and the deal feature values into the database; train the machine learning model with the investor feature values and the deal feature values, and send a notification message to each investor once the recommended deals have been determined for that investor. The database has placeholders for a plurality of investor feature categories, a plurality of deal feature categories, a plurality of investor scores, and a plurality of deal scores. The investor data is based on a plurality of investor features. The deal data based on a plurality of deal features. The investor constraints are factored into the investor feature values during normalization. The deal constraints are factored into the deal feature values during normalization. The machine learning data model is configured to receive available normalized investor feature data into corresponding investor feature categories in the machine learning model, receive available normalized deal feature data into corresponding deal feature categories in the machine learning model, determine an overall investor score for each investor in the plurality of investors, determine an overall deal score for each deal in the plurality of deals, and determine a plurality of recommended deals for each investor based on the overall investor scores and the overall deal scores. Each overall investor score is determined using at least one of a plurality of investor score determination methods based on a subset of the available normalized investor feature data. Each overall investor score is stored in the database. Each overall deal score is determined using at least one of a plurality of deal score determination methods based on a subset of the available normalized deal feature data. Each overall deal score is stored in the database.

In accordance with another aspect of the present disclosure, there is provided a computer-implemented method of recommending transactions. The computer-implemented method comprises obtaining investor data for a plurality of investors, obtaining deal data for a plurality of deals, normalizing the investor data into investor feature values, normalizing the deal data into deal feature value, populating the investor feature values and the deal feature values into a database, training a machine learning model with the investor feature values and the deal feature values, determine an overall investor score for each investor in the plurality of investors, determine an overall deal score for each deal in the plurality of deals, and determine a plurality of recommended deals for each investor based on the overall investor scores and the overall deal scores, and sending a notification message to each investor once the recommended deals have been determined for that investor. The investor data is based on a plurality of investor features. The deal data based on a plurality of deal features. The investor constraints are factored into the investor feature values during normalization. The deal constraints are factored into the deal feature values during normalization. Each overall investor score is determined using at least one of a plurality of investor score determination methods based on a subset of the available normalized investor feature data. Each overall investor score is stored in the database. Each overall deal score is determined using at least one of a plurality of deal score determination methods based on a subset of the available normalized deal feature data. Each overall deal score is stored in the database.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates an example of a recommendation engine platform, in accordance with some embodiments;

FIG. 2A illustrates, in a flowchart, an example of a method of recommending a transaction/deal using risk score matching, in accordance with some embodiments;

FIG. 2B illustrates, in a flowchart, another example of a method of recommending a deal, in accordance with some embodiments;

FIG. 3 illustrates an example of a client dataset, in accordance with some embodiments;

FIG. 4 illustrates an example of a chart showing percentage of true values by percentage of observed values per column, in accordance with some embodiments;

FIG. 5 illustrates an example of a deal information dataset, in accordance with some embodiments;

FIG. 6 illustrates an example of matching client risk scores with transaction/deal scores, in accordance with some embodiments;

FIG. 7 illustrates an example of content-based filtering, in accordance with some embodiments;

FIGS. 8A and 8B illustrate an example of collaborative filtering, in accordance with some embodiments;

FIG. 9 illustrates an example of generation of a client-deal interaction matrix, in accordance with some embodiments;

FIG. 10 is a schematic diagram of a computing device such as a server or other computer;

FIG. 11 illustrates an example of a recommendation system architecture, in accordance with some embodiments;

FIG. 12 illustrates, in a sequence diagram, an example of API-Driven Recommendation Generation and Persistence Flow, in accordance with some embodiments;

FIG. 13 illustrates an example of machine learning operations for training, validating and versioning a machine learning (ML) data model for recommendation system, in accordance with some embodiments;

FIG. 14 illustrates, in a high-level flowchart, an example of an offline recommendation model generation phase for model formation and training, in accordance with some embodiments;

FIG. 15 illustrates an example of a synchronous, real-time method for serving personalized investment recommendations to a client application, in accordance with some embodiments; and

FIG. 16 illustrates an example of a cold-start decision and recommendation generation flow, in accordance with some embodiments.

It is understood that throughout the description and figures, like features are identified by like reference numerals.

### DETAILED DESCRIPTION

Embodiments of methods, systems, and apparatus are described through reference to the drawings. Applicant notes that the described embodiments and examples are illustrative and non-limiting. Practical implementation of the features may incorporate a combination of some or all of the aspects, and features described herein should not be taken as indications of future or existing product plans.

The present disclosure relates generally to computer-implemented recommendation systems and, more particularly, to systems and methods for generating compliant, explainable, and personalized recommendations of private-market investment opportunities for investors in regulated financial environments.

Conventional recommendation systems typically apply a retrieval technique or perform ranking directly over a full inventory of items. Such systems often fail in regulated domains because they do not enforce eligibility and compliance constraints prior to model execution, leading to invalid or non-compliant recommendations. Additionally, retrieval approaches suffer from cold-start bias, exposure bias, and lack of explainability.

The disclosed embodiments relate to computer-implemented systems for generating recommendations, and more particularly to systems and methods for generating candidate items for recommendation in regulated and constraint-driven environments. The disclosed systems integrate multiple varied relevance-scoring techniques and employ an explainable combination mechanism to produce recommendations that are both technically robust and suitable for regulatory review, while remaining scalable for near real-time operation.

There exists a need for a technical recommendation architecture that (i) enforces investor-specific and deal-specific eligibility constraints prior to any scoring or ranking, (ii) integrates multiple independent relevance signals in a principled and explainable manner, (iii) produces a ranked set of recommendations that can be justified using human-readable logic, (iv) optionally supports automated capital allocation under portfolio-level constraints, and (v) continuously learns from investor outcomes while maintaining an auditable model lifecycle.

The systems and methods described herein address these needs by providing a compliance-first, hybrid recommendation framework in which investor eligibility profiles and deal eligibility rule sheets are constructed from multi-source data and applied as a hard filtering stage before any recommendation models are executed. Eligible investment opportunities are then evaluated using a plurality of independent scoring models, including collaborative filtering, content-based similarity, and deep neural retrieval. The resulting heterogeneous scores are normalized and fused using an adaptive neuro-fuzzy inference system (ANFIS) that combines data-driven learning with interpretable fuzzy rules to generate a final relevance score for each eligible deal.

In some embodiments, the disclosed system further ranks the eligible deals and presents a minimum number of top-ranked recommendations together with rule-based explanations derived from the ANFIS fusion process. In some embodiments, the system additionally generates an automated investment allocation plan that allocates investor capital among selected deals while enforcing concentration limits, liquidity constraints, and suitability requirements. In some embodiments, the system captures explicit and implicit investor outcomes and periodically retrains one or more underlying models using a structured feedback loop, thereby improving recommendation performance over time while preserving traceability and auditability.

In some embodiments, a recommendation engine is provided that recommends resource of a first type to resources of a second type. In the private equities industry, this can be interpreted as a deal (resource of a first type) being recommended to investors (resource of a second type). It should be noted that the terms “client” and “investor” are used interchangeably herein. Specifically, an “investor” is a type of client. It should also be noted that the terms “deal” and “transaction” are sometimes used interchangeably herein. Specifically, a “deal” is an offer or opportunity to participate in an investment “transaction” for that deal.

While the recommendation engine associates resources of the first type with resources of the second type, a technical challenge arises in generating accurate, compliant, and timely recommendations in the presence of continuously changing data. Investor or client data, including eligibility status, accreditation validity, portfolio composition, and behavioral signals, may change over time. Likewise, deal or transaction data, including availability, minimum investment thresholds, jurisdictional restrictions, and risk characteristics, may be updated or withdrawn. These dynamic changes create high-dimensional and time-varying interrelationships between investors and deals that are difficult to model using a single retrieval or scoring technique. Furthermore, investor behavioral signals, such as interaction events and historical commitments, introduce additional complexity that must be incorporated without violating eligibility constraints or sacrificing explainability. The disclosed embodiments address these technical challenges through a structured recommendation architecture that enforces constraints prior to scoring, integrates multiple independent relevance signals, and produces explainable outputs suitable for regulated environments.

In some embodiments, a private market recommendation engine is provided that allows users (i.e., clients/investors) to be matched with deals (investment opportunities) for private equity products (e.g., private stock, private shares, real estate shares, other private equity or private credit products, and/or non-fungible private property). This is different from the public market recommendation engine because the private market has different regulations on the sale of securities or fungible assets due to differences arising in the nature of the securities or fungible assets. For example: (1) private equity securities are not available to everyone as there are limits based on investor net worth and knowledge etc.; (2) some private equity securities are not liquid (e.g., real state); (3) there is currently no standardized data or governance models for private equity data; and (4) often the assets within a private equity asset class in private markets are more heterogeneous than those in public markets (e.g., no two houses in real estate are same) and hence assets are not fungible. These variations in assets and variations in process, render it not possible to use any existing public equity models. Given these differences, price discovery is less uniform and less consistent, making private equity valuations more dependent on fundamental values rather than through market participants.

In some embodiments, interfaces filter logic and use direct filters (e.g., geography of investment/type of security) or a weighted calculation of sum of responses to given questions dividing into buckets of low, medium and high risk.

In some embodiments, a combination of stated preferences (e.g., responses to questions), and investor behavior display (where customer/investor interest is tracked, and engagement levels as measured in time spent on an investment page engaging with content, clicking on investment button, starting a transaction creation process (and how far they go), same customer/investor registering for a webinar related to a deal/industry, and asking investment questions. These investor behavioural aspects may be tracked across a platform, website, emails, and other marketing channels, and consolidated in a customer relationship management (CRM) tool or database, for a comprehensive behavioural study and scoring. The clustering of this information, can be interpreted as indicia for the customer/client/investor's likely investment behaviour.

In some embodiments, an investment platform is provided specializing in real estate. Artificial intelligence (AI) tools may be developed to recommend deals to clients based on information about the clients (i.e., investors) and the deals. Client/investor information may include demographic information, risk behavior and investing behavior. Demographic information may include age, gender, income, family income, marital status, etc. Risk behavior may include an expected time horizon for an account, a length of time before regular withdrawals/distributions are required, how many years of savings are available for emergencies, how much loss/gain can be tolerated with an investment amount (e.g., $80,000), etc. Investing behavior includes a number of buy button clicks, invested deals, etc. Deals information may include a deal category, a sponsor, a sponsor risk, projected returns, sector returns, liquidity, etc.

Several recommendation determination approaches are described below, including Deep Learning, Risk Score Matching (calculate risk scores for investors and deals; and match deals to clients based on the score ranges), Content-Based Filtering, and Collaborative Filtering, Hybrid Adaptive Neuro-Fuzzy Inference System (ANFIS), Reinforcement Learning. In some embodiments, responses from two or more recommendation determination approaches may be combined into a hybrid approach to determine overall risk scores used to determine recommendations.

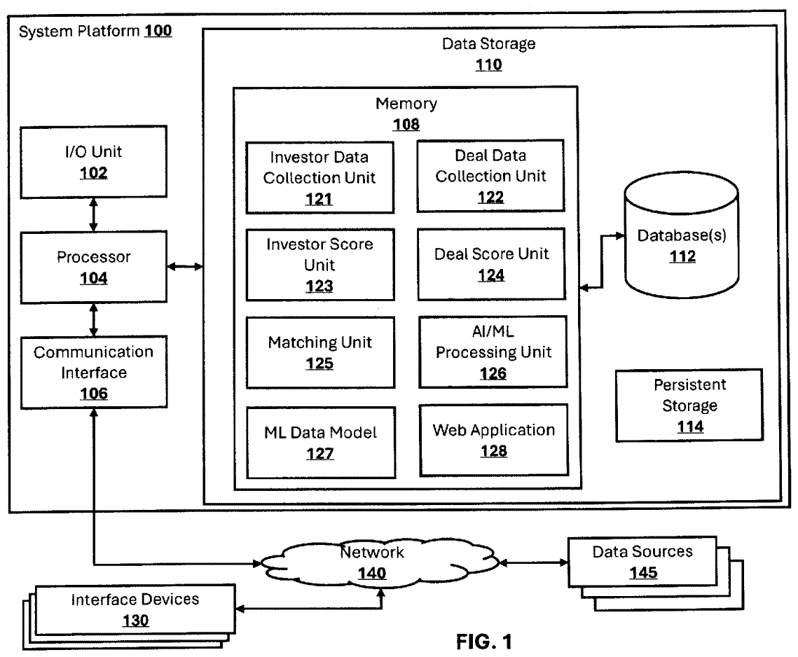

FIG. 1 illustrates an example of a recommendation engine platform 100, in accordance with some embodiments. The platform 100 may include an electronic device connected to an interface application 130 such as a data dashboard implemented on a mobile device, and external data sources 145 via a communication network 140 (or multiple networks including Wi-Fi, Bluetooth or other wireless communication technology). The platform 100 can implement aspects of the processes described herein.

The platform 100 may include at least one processor 104 and a memory 108 storing machine executable instructions to configure the at least one processor 104 to receive data. The at least one processor 104 can receive a trained neural network and/or can train a neural network using a machine-learning engine 126. The platform 100 can include an input/output (I/O) Unit 102, communication interface 106, and data storage 110. The at least one processor 104 can execute instructions in memory 108 to implement aspects of processes described herein.

The platform 100 may be implemented on an electronic device and can include an I/O unit 102, the at least one processor 104, a communication interface 106, and a data storage 110. The platform 100 can connect with one or more interface devices 130 or other data sources. This connection may be over a network 140 (or multiple networks). The platform 100 may receive and transmit data from one or more of these via I/O unit 102. When data is received, I/O unit 102 transmits the data to processor 104.

The I/O unit 102 can enable the platform 100 to interconnect with one or more input devices, such as a keyboard, mouse, camera, touch screen and a microphone, and/or with one or more output devices such as a display screen and a speaker.

The at least one processor 104 can be, for example, any type of general-purpose microprocessor or microcontroller, a digital signal processing (DSP) processor, an integrated circuit, a field programmable gate array (FPGA), a reconfigurable processor, or any combination thereof.

The data storage 110 can include memory 108, database(s) 112 and persistent storage 114. Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 can connect to different machines or entities.

The data storage 110 may be configured to store information associated with or created by the platform 100. Storage 110 and/or persistent storage 114 may be provided using various types of storage technologies, such as solid-state drives, hard disk drives, flash memory, and may be stored in various formats, such as relational databases, non-relational databases, flat files, spreadsheets, extended markup files, etc.

The memory 108 may include a client/investor data collection unit 121, a deal/transaction data collection unit 122, a client/investor risk score unit 123, a deal/transaction risk score unit 124, a matching/recommendation unit 125, and an AI/machine-learning (ML) processing unit 126. As will be described below, the matching/recommendation unit 125 performs more than merely matching a single client to a single transaction. In some embodiments, the matching/recommendation unit 125 matches at least two clients to each transaction. These units 121, 122, 123, 124, 125, 126 will be described in more detail below. In some embodiments, the AI/ML processing unit 126 will include a model. In other embodiments, the model will be stored separately in memory 108. It should be noted that other units may be added to the memory 108, including a web application unit for hosting access to the platform 100 via, for example, software as a service (SaaS).

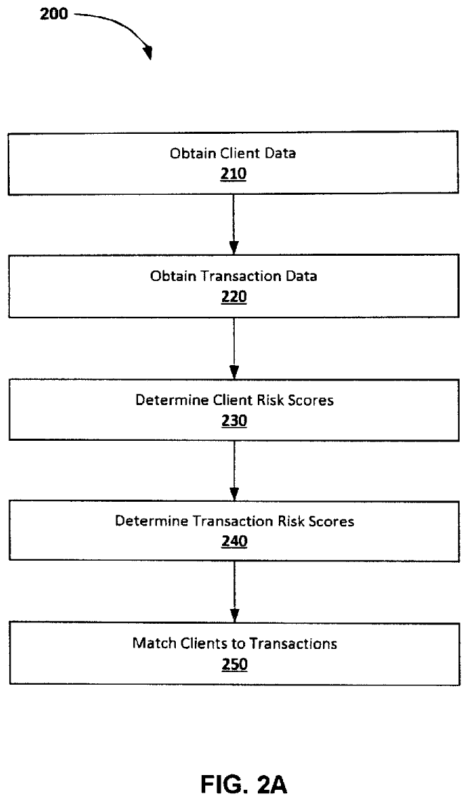

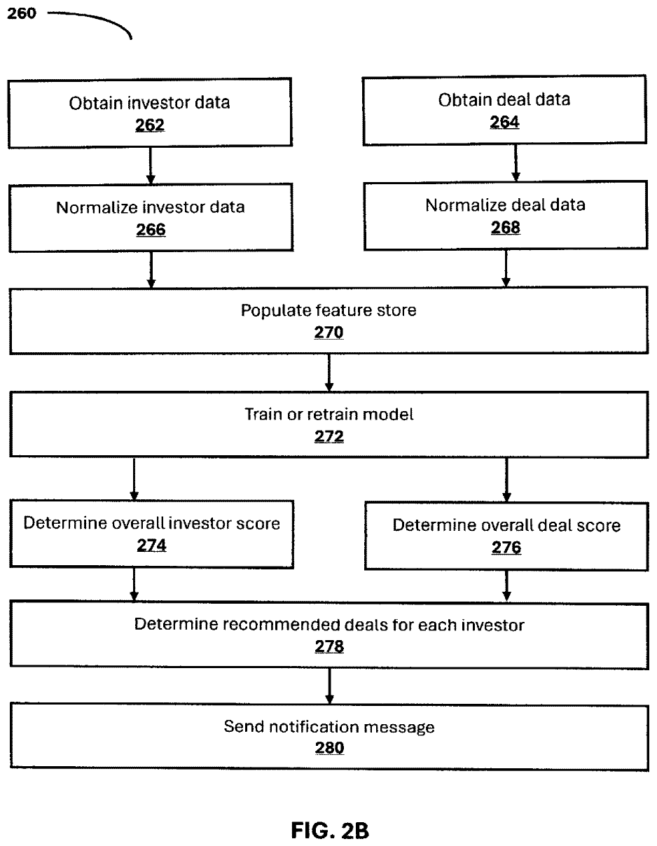

FIG. 2A illustrates, in a flowchart, an example of a method of recommending a deal/transaction 200, in accordance with some embodiments. The method 200 includes obtaining investor/client data 210, obtaining deal/transaction data 220, determining a client/investor risk score 230 for each investor/client in the investor/client data, determining a deal/transaction risk score 240 for each deal/transaction in the deal/transaction data, matching or recommending 250 at least two investor/client risk scores to at least one deal/transaction. Other steps may be added to the method 200, including automatically initiating the at least one deal/transaction with at least one of the associated investors/clients. Matching or recommending 250 investor/clients and deals/transactions may be performed in different ways, as will be further described below.

FIG. 2B illustrates, in a flowchart, another example of a method of recommending a deal 260, in accordance with some embodiments. The method 260 includes obtaining 262 investor data for a plurality of investors, obtaining 264 deal data for a plurality of deals, normalizing 266 the investor data, normalizing 268 the deal data, populating 270 the normalized investor data and the normalized deal data into a database (e.g., feature store that may be one of database(s) 112), training (or retraining) 272 a ML model with the feature values, determining 274 an overall investor score for each investor in the plurality of investors, determining 276 an overall deal score for each deal in the plurality of deals, determining 278 a recommendation of at least three deals for each investor based on the investor scores and the deal scores, and sending 280 a notification message to each investor once the at least three deals have been determined for that investor. The feature store (i.e., database) includes placeholders for a plurality of investor feature categories and a plurality of deal feature categories. During data collection 262, 264, the investor data is collected based on a plurality of investor features stored in the feature store and used for creating the machine learning model, and the deal data is collected based on a plurality of deal features stored in the feature store and used for creating the machine learning model. During normalization 266, 268, investor constraints are factored into the normalized investor data, and deal constraints are factored into the normalized deal data. During data population 270, available normalized investor feature data into corresponding investor feature categories in the feature store (i.e., database), and available normalized deal feature data into corresponding deal feature categories in the feature store. Each overall investor score may be determined using at least one of a plurality of investor score determination methods described below.

For each investor score determination method where there is sufficient available normalized investor feature data, an investor score for that investor will be calculated using that determination method. If there are more than one investor scores determined for an investor, then a hybrid approach will be used to determine the overall investor score for that investor. Similarly, for each deal score determination method where there is sufficient available normalized deal feature data, a deal score for that deal will be calculated using that determination method. If there are more than one deal scores determined for a deal, then a hybrid approach will be used to determine the overall deal score for that deal. All investor scores, overall investor scores, deal scores and overall deal scores are stored in placeholders in the database.

Investor data and deal data may change periodically. It is desirable to have all scores stored in the database to be update in (near) real-time. Thus, once investor and/or deal data is changed, the relevant features in the data model may be updated (following normalization of the updated data), and any relevant scores may also be automatically updated (in (near) real-time upon the data features being updated in the database. For example, once a value is updated in the database, an action is triggered to automatically retrain the model and update the scores. It should be understood that any relevant score means any score that is dependent upon the updated data. In this manner, a large volume of investors, deals and corresponding scores may be up-to-date on a nearly continuous basis. Since the scores are up-to-date, any recommendation dependent upon an updated score may be re-determined. Notification messages may then be sent to any investor where their recommendation has changed.

In some embodiments, the method 260 may further include automatically initiating a transaction for any deal recommended to a particular investor when the overall deal score for the recommended deal is within a threshold deviation from the overall investor score for that particular investor.

Additionally or alternatively, AI may be used to determine, monitor, and store in the database, any investor behavior on the platform 100, or any investor transaction history. Such investor behavior data may be normalized (and quantified) to be used by some investor score determination methods. Any updates to the database effected by investor behavior may take place as described above to update scores and recommendations.

Additionally or alternatively, monthly reports may be sent to investors explaining why recommendations were made and/or updated.

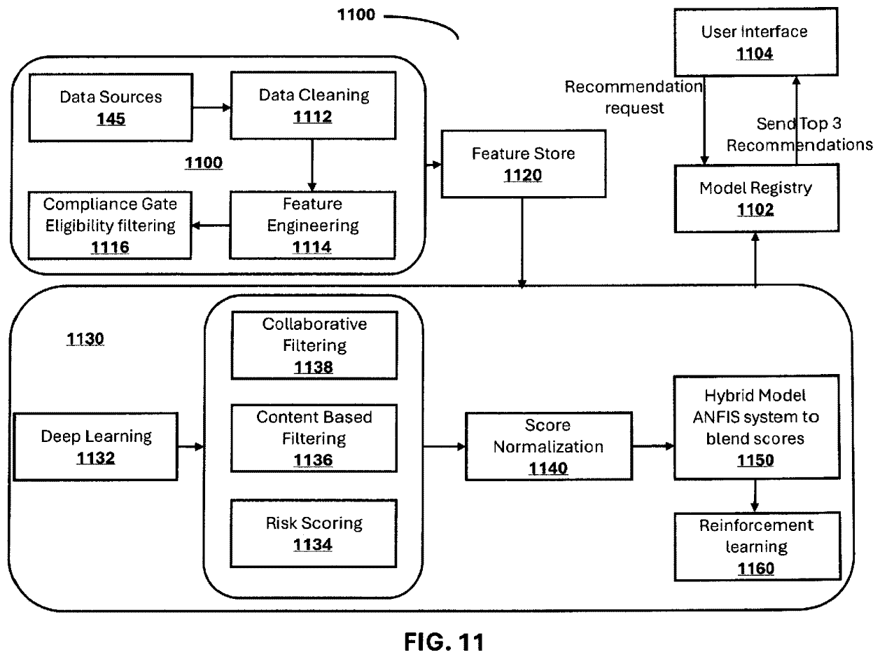

FIG. 11 illustrates an example of a recommendation system architecture 1100, in accordance with some embodiments. It should be understood that the architecture 1100 describes the platform 100 from a different functional perspective. The functionality described using the architecture 1100 may be implemented by units in the memory 108. A client web application 128 (which communicates with a client device (e.g., mobile phone, tablet, laptop, computer, etc.)) initiates a recommendation request by transmitting investor context information to a model registry 1102. The model registry 1102 then uses the currently hosted machine learning model 127 in use, and obtains recommended deals for the investor. In some embodiments, the top three recommendations are sent to the user interface 1104 of the client web application 128. It should be understood that any number of recommendations may be sent, preferably more than one.

The model registry 127 is prepared before a client web application initiates a recommendation request. Initially, investor and deal data are collected and preprocessed 1110. For example, the investor data collection unit 121 and the deal data collection unit 122 receive investor data and deal data, respectively, from the data stores 145. The investor data and deal data are normalized, including data cleaning 1112. Features are extracted from the data (feature engineering 1114) and eligibility, regulatory, and suitability constraints are applied (compliance gate eligibility filtering 1116). A set of features is generated using multiple independent retrieval mechanisms, including content-based retrieval, collaborative filtering retrieval, cohort-based retrieval, and inventory-balancing retrieval. These features are stored in a feature store 1120. The features are then sent to a machine learning unit 126 to be processed (e.g., investor scores and deal scores determined). It should be noted that the investor score unit 123, data score unit 124, matching unit 125 and AI/ML processing unit 126 may be implemented into one data processing unit 1130 that performs scoring and alignment, score normalization 1140 and fusion, and ranking.

### High-Level Architecture Overview

Table 1 shows an example of a high-level architecture overview. The stage, core function, primary methods, and output are provided.

TABLE 1
High-Level Architecture Overview

| Stage | Core Function | Primary Method(s) | Output |
|---|---|---|---|
| 1. Data | Ingest, clean, balance, and | Extract, Transform and | Financial DNA |
| Preparation | feature-engineer raw | Load data. | vectors for |
| | investor & deal data. | Feature engineering | investors and |
| | Implement House Price | techniques | deals; |
| | Prediction model to enhance | | Eligibility Rules |
| | real estate deal data | | (compliance |
| | | | gates). |
| 2. Candidate | Generate a smaller set of | Two-Tower Deep | Top eligible deal |
| Retrieval | potentially relevant deals for | Retrieval (deep- | candidates. |
| | a given investor. | learning embeddings) | Deep Retrieval |
| | | | score S_{DL} |
| 3. Scoring & | Produce heterogeneous | Collaborative Filtering | Raw scores |
| Alignment | relevance scores for each | (+Content-Based | S_{CF}, S_{CB}, S_{RS}. |
| | candidate. | Similarity + Risk score | |
| 4. Score | Convert heterogeneous | Score Matching / | Final Ranked |
| Normalisation | scores to a common scale | Alignment (min-max / | Score S_{final}· |
| & Fusion | and combine them in an | z-score + isotonic | |
| | explainable way. | calibration) + ANFIS | |
| | | (neuro-fuzzy rules) | |
| 5. Ranking & | Order deals and surface the | Ranking (sorted by | Rule-based |
| Presentation | top-K with human-readable | S_{final}) | justification, |
| | explanations. | | robotic- |
| | | | investment plan. |
| 6. Long-Term | Choose the subset of deals | Reinforcement | Top 3 |
| Optimisation | to present (or allocation | Learning Contextual | recommended |
| | suggestion) while respecting | Bandit | deals |
| | safety constraints. | | |
| 7. Feedback | Capture explicit & implicit | Retraining | New machine |
| Loop | outcomes and feed them | | learning model |
| | back to the training set. | | version |

The core function of the data preparation stage ingests, cleans, balances, and feature-engineers raw investor and deal data (or signals). Extraction, transform and load (ETL) methods may be used to generate a feature store 1120. Financial DNA vectors for investors and deals are also generated that comply with eligibility rules (compliance gates). In some embodiments, a house price prediction model may be used to enhance real estate deal features.

A smaller set of potentially relevant deals for a given investor using methods such as Two-Tower Deep Retrieval (deep learning neural network) to produce the top eligible deal candidates.

Scoring and alignment produces heterogeneous relevance scores for each candidate using collaborative filtering, content-based similarity such as cosine over engineered vectors, and risk scoring. Raw scores are output such as a collaborative filtering score (S_{CF}), a content-based similarity score (S_{CB}) and/or a deep learning score (S_{RS}).

In the score normalization 1140 and fusion convert stage, heterogeneous scores to a common scale and combines them in a manner that is explainable to a client/investor. Score matching/alignment (such as min-max/z-score), isotonic calibration techniques, and ANFIS (neuro-fuzzy rules) methods are used to output a final or overall ranked score (S_{final}).

Ranking and presentation orders deals and surface the top N deals with human-readable explanations. The top N deals are selected by ranking S_{final}. The output includes displaying the Top 3 (or Top N) recommended deals, displaying a rules-based justification for the recommendation, and/or implementation of a robotic investment plan.

Long-term optimisation (e.g., reinforcement learning/Bandits) may be used to select the subset of deals to present (or an allocation suggestion) while respecting safety constraints. Contextual bandit/reinforcement learning may be used to output which three (or N) deals (or allocation weights) to display or use.

A feedback loop may capture explicit and implicit outcomes arise from recent changes in data or new data from client behavior and feed the same back to the training set. A data pipeline may be used to output updated training data used to re-train models (Deep Learning Two tower 1132, Risk Scoring 1134, Collaborative filtering 1136, content-based filtering 1138, ANFIS 1150, reinforcement learning 1160).

In some embodiments, the order of algorithmic usage may be:
1. Two-Tower Retrieval (deep learning based candidate generation)
2. Risk based scoring (investor and deal risk compatibility)
3. Collaborative Filtering (derive implicit preference signal from historical investor-deal interactions)
4. Content-Based Similarity (derive explicit preference signal from investor and deal attributes)
5. Score Alignment and ANFIS Fusion (combine and explainable scoring outputs)
6. Reinforcement Learning using Bandit based Selection (perform final safe-set optimisation and recommendation selection)

In some embodiments, one or more of the stages may operate in parallel, be conditionally executed, or be weighted differently depending on data availability, including cold-start conditions. Additional processes, including eligibility filtering, data cleaning, feature engineering, and loss-function optimization, are performed before, after, or alongside the core stages. The stages of the high-level architecture overview will be further described below.

### Data Preparation and Preprocessing

Table 2 lists examples of data preparation regarding the collection of data. The source and content, and frequency or arrival information of data is provided.

TABLE 2
Data Sources

| | | Frequency / |
|---|---|---|
| Source | Content | Arrival |
| CRM Call Notes | Textual investor conversation snippets, sentiment tags, | Real-time (as calls |
| | disclosed preferences; summaries of phone calls: what | are logged). |
| | they said they like, risk appetite, “must-have” sectors. | |
| Portal | Click-streams, data-room opens/downloads, time-on- | Event-driven (real- |
| Interaction Logs | page, skip events; every click/scroll/time spent; | time). |
| | open/download flags. | |
| KYC/AML & | Legal status, jurisdiction, accreditation expiry dates; | Periodic / |
| Accreditation | proof investor may invest in certain jurisdictions and | whenever status |
| | meets thresholds. | changes. |
| / Funding Events | commitment amount, settlement timing, source account | Transactional (per |
| | information | commitment). |
| Investor | Investor responses to marketing communications, | Event-driven (real- |
| Marketing | including webinar registrations, attendance duration, | time or near real- |
| Engagement | early exit behavior, podcast listens, email open and click | time). |
| Logs | events, and interaction depth metrics indicating | |
| | engagement with educational or promotional content. | |
| Deal Database | Deal attributes including deal terms, sponsor track- | Updated upon |
| | record, IRR (internal rate of return) target, expected hold | each new offering. |
| | period, asset class, minimum investment amount, | Updated upon |
| | concentration limits, ESG tags | subsequent deal |
| | | lifecycle events |
| Deal Marketing | Deal-level marketing attributes including campaign type, | Updated per |
| and Promotion | number of promotional events, communication channels | campaign or |
| Data | used, timing and frequency of outreach, and aggregate | promotional event. |
| | engagement metrics associated with each promotional | |
| | effort. | |
| Educational | Investor interactions with educational content such as | Event-driven. |
| Content | webinars, podcasts, videos, news letters, whitepapers or | |
| Interaction Logs | articles, including time spent, completion status, repeat | |
| | interactions, and drop-off points. | |

Additional data sources may include market indicators, sponsor activity signals, portfolio exposure metrics, recommendation outcome logs, and compliance metadata used to enhance relevance, explainability, and regulatory auditability.

Table 3 lists examples of operations and their details related to data cleaning and balancing.

TABLE 3
Data Cleaning and Balancing

| Operation | Detail |
|---|---|
| Schema | Convert monetary values to a common currency; align date and time |
| Normalisation | formats; standardize categorical fields by mapping free-text inputs to |
| | controlled vocabularies (e.g., “Biotech” → “Biotechnology”). |
| Text Processing and | Process unstructured text sources, including CRM call notes and |
| Signal Extraction | educational content summaries, using tokenization, keyword extraction, |
| | sentiment tagging, and topic classification to generate structured |
| | investor preference and intent features. |
| | Apply natural language processing and generative Al models to |
| | unstructured text sources, including CRM call notes, emails, webinar |
| | transcripts, and educational content, to extract structured |
| | representations of investor intent, sentiment, stated preferences, and |
| | topic relevance. |
| Missing-Value | Impute missing numerical values using statistical derived measures |
| Imputation | such as medians. Impute missing categorical values using placeholder |
| | categories such as “Unkown”. Wherever applicable several machine |
| | learning and statistical methods are used to predict the missing values. |
| Sparse-Interaction | Address sparsity in private-market interaction data by applying |
| Balancing | rebalancing techniques, including stratified undersampling of highly |
| | overrepresented deal interactions and oversampling of |
| | underrepresented or niche strategy matches (e.g., impact-focused real |
| | estate), to mitigate concentration or single-deal bias. |
| Exposure and | Normalize interaction and conversion signals by accounting for |
| Marketing Bias | differential deal exposure arising from marketing campaigns, |
| Correction | promotional frequency, or recommendation repetition, thereby |
| | separating investor interest from exposure-driven effects. |
| De-duplication | Identify and remove duplicate investor-deal interaction records and |
| | resolve entity identities across data sources, including investors, |
| | sponsors, deals, and marketing campaigns, using deterministic or |
| | probabilistic matching techniques. |
| Eligibility Rule | Generate an investor compliance profile based on jurisdiction, |
| Generation | accreditation status, ticket-size limits, and concentration constraints, |
| | and generate a corresponding deal eligibility rule set across similar |
| | dimensions. Store the compliance profiles and eligibility rules as |
| | immutable, machine-readable representations in a feature repository to |
| | enforce legal and regulatory gating prior to recommendation generation. |
| Recommendation | Label recommendation events with outcome indicators including |
| Outcome Labeling | viewed, ignored, dismissed, saved, or invested, and associate |
| | outcomes with model version, rule set, and delivery context to support |
| | reinforcement learning and offline evaluation. |
| Audit and Version | Associate cleaned data with metadata identifying acknowledge model |
| Alignment | versions, feature schemas, and rule configurations to ensure |
| | traceability, reproducibility, and regulatory auditability. |

Cleaning operations ensure data consistency through normalization of currencies, dates, and categorical representations, and through application of statistically derived default values where required. Balancing operations mitigate popularity and concentration bias by preventing overrepresentation of highly exposed deals in recommendation outputs. Eligibility and suitability rules establish a non-negotiable legal and regulatory gating layer that must be satisfied before any recommendation output is generated or displayed. In some embodiments, generative artificial intelligence models are used to augment data preparation, feature construction, and explainability processes without altering deterministic eligibility or risk constraints.

### Feature Engineering “Financial DNA”

Client information may comprise a dataset of investor profile information. Features may include, but are not limited to: User ID, Invested Deals, Buy Button Clicks, Type of Investor Account, Age, Gender, Marital Status, Number of Dependents, City, Country, Province, Postal Code, Employment Type, Employer Name, Job Title, Years with Company, Annual Income, Total net assets, and risk preference and suitability questions. Example suitability questions may include: expected investment time horizon for the account and number of years before a significant withdrawal is expected. In one example implementation, the dataset may include approximately 5,597 investors and 39 investor features. It should be understood that different numbers of investors and features may be implemented without departing from the scope of the present disclosure.

Deal information may comprise a dataset of existing deals (available investment opportunities). In some embodiments, deal features include, but are not limited to: Deal ID, Preliminary Risk Score, Geographical Location, Deal Category, Sponsor, Sponsor Risk, Returns—Deal, Returns—Sector, Risk (standard deviation (stdev))—Sector, Sector, Investment Recommendations (Sell), Project Term (years), Liquidity, Leverage Ratio (Debt/Assets) etc. In one example, the dataset may include 26 deals and 16 features. It should be understood that different numbers of deals and features may be implemented. Table 4 shows examples of client/investor and transaction/deal feature categories.

TABLE 4
Client and Transaction Features

| | Investor Data | Deal Data |
|---|---|---|
| Category | (Who the investor is / wants) | (What the deal offers) |
| Investor / Deal Type | Type of investor (Individual, | Intended investor type for the |
| | Corporate, RRSP, Trust) | deal |
| Eligibility & Suitability | Investor accreditation status | Investor eligibility or |
| | (Accredited, Eligible, Non-Eligible) | accreditation requirements |
| Financial Capacity | Total net assets and net worth | Minimum investment amount |
| | excluding primary residence | required |
| Affordability | Income history and overall financial | Deal size and target capital |
| | capacity | |
| Liquidity Needs | Emergency savings available (in | Lock-up period or expected |
| | months) | investment duration |
| Withdrawal Expectations | Expected timing of significant or | Liquidity characteristics of the |
| | regular withdrawals | deal |
| Risk Tolerance | Willingness to assume investment | Overall risk classification of the |
| | risk | deal (Low / Medium / High) |
| Behavior in Market | Likely reaction to declining or | Volatility and uncertainty |
| Stress | volatile markets | associated with the deal |
| Return Expectations | Target or expected rate of return | Expected annualized rate of |
| | | return |
| Investment Objectives | Primary objective (Income, Growth, | Return profile and income vs |
| | Preservation, Balanced) | growth orientation |
| Investment Time | Intended investment holding period | Expected duration or term of the |
| Horizon | | deal |
| Sector Preference | Implied or stated preference for | Industry or market sector of the |
| | certain industries | deal |
| Geographic Preference | Implied geographic interest (if | Geographic focus of the deal |
| | observed) | |
| Sophistication & | Experience level, co-investing | Sponsor designation and |
| Experience | history, financial sophistication | experience level |
| Trust & Track Record | Preference for experienced | Historical performance and track |
| | sponsors | record |
| Engagement Level | Frequency of reviewing and | Investor engagement metrics for |
| | engaging with deals | the deal |
| Decision Intent Signals | Clicks, time spent, repeat visits | Views, click-through rates, |
| | | watchlist activity |
| Social Proof Sensitivity | Responsiveness to peer or market | Number of investors already |
| | signals | committed |
| Momentum Sensitivity | Tendency to respond to trending | Funding momentum (Fast, |
| | opportunities | Steady, Slow, Unclear) |
| Marketing | Responsiveness to emails, | Promotional and marketing |
| Responsiveness | webinars, social content | efforts undertaken |
| Communication Channel | Preference for email, webinars, | Channels used for deal |
| Preference | social media | promotion |
| Education Engagement | Webinar attendance and interaction | Webinars hosted for the deal |

The feature details in Table 4 allows explainable recommendations such as: “This deal matches your risk tolerance, time horizon, and return objectives, and has strong investor momentum.”

Table 5 shows examples of attributes that only apply to investors/clients or only apply to deal/transactions.

TABLE 5
Investor-Only and Deal-Only Attributes

| Investor-Only Attributes | Deal-Only Attributes |
|---|---|
| Whether the investor is a registered dealer | Capital already raised |
| Whether the investor is a financial institution | Total number of investors committed |
| Debt servicing ratio | Share price history (initial vs current) |
| Use of borrowed funds for investing | Total distributions from prior deals |
| Household income history | Marketing campaign count and timing |
| Personal behavioral traits unrelated to a single deal | (Sponsor branding and public visibility |

Table 6 shows examples of attributes that are common to both investor and deal features.

TABLE 6
Common Attributes

| Category | Example Features | Representation |
|---|---|---|
| Investor | risk_tolerance (Low/Medium/High), liquidity_needs | Numerical bins + |
| Profile | (Short/Medium/Long), ticket_size_range (USD), | one-hot vectors. |
| | preferred_sectors (multi-label), average_ticket_usd, | |
| | accreditation_status, geography_preference. | |
| Deal Profile | IRR_target, hold_period_months, sponsor_quality_score, | Numerical + |
| | asset_class (RE, VC, PE), min_ticket_usd, structure_type | categorical |
| | (equity, preferred equity, debt), sector, geography, | embeddings. |
| | ESG_score. | |
| Behavioural | recent_deposit_amount, days_since_last_deposit, | Scaled continuous |
| Signals | data_room_dwell_seconds, download_flag, | variables. |
| | click_through_rate. | |
| Derived | sector_overlap_score, risk_band_match, | Cosine similarity |
| Similarity | ticket_closeness_ratio, horizon_alignment. | over embeddings. |
| Vectors | | |

### Future Home Prices Embodiments (Home Price Prediction Model)

In some embodiments, there are provided techniques to predict future house prices, including a Future House Price Model and a system designed to estimate the future value of houses for 1-year, 3-year, and 5-year time horizons. This model leverages key data components, including MLS data, Google locations, and macroeconomic indicators, utilizing multiple algorithms such as Neural Net, Long Short Term Memory (LSTM), Autoregressive Integrated Moving Average (ARIMA), and a social media algorithm.

Home price prediction is used in data preparation for real estate investment deals for several reasons, including financial foundation and risk assessment, enhanced feature engineering for investment metrics, and market intelligence and competitive advantage.

Financial Foundation and Risk Assessment: The home price prediction model is integrated into the data preparation module because it transforms raw property data into investment-grade financial intelligence. Unlike residential buyers who focus on lifestyle preferences, private investors require accurate valuation metrics to assess deal viability, calculate potential returns, and evaluate downside risks. The price prediction model enriches the dataset with financial features such as fair market value, appreciation forecasts, and volatility indicators that become the foundation for all subsequent recommendation algorithms. Without these price-derived features, the system would be recommending properties based on superficial characteristics rather than fundamental investment merit, potentially exposing investors to significant financial losses.

Enhanced Feature Engineering for Investment Metrics: During data preparation, the price prediction model generates sophisticated investment-focused features that are impossible to derive from raw property data alone. These include affordability scores relative to investor budgets, return on investment (ROI) potential calculations, market percentile rankings, and comparative pricing analysis against similar properties. The model also creates temporal features like price trend momentum, seasonal adjustment factors, and market cycle positioning that enable the recommendation system to understand not just what properties are available, but when they represent optimal investment opportunities. This enhanced feature set allows downstream algorithms to make nuanced distinctions between properties that may appear similar on surface characteristics but differ dramatically in investment potential.

Market Intelligence and Competitive Advantage: The price prediction model serves as a market intelligence engine within the data preparation phase, providing real-time insights into market dynamics that give investors a competitive edge. It identifies undervalued properties where current listing prices are below predicted fair market value, detects emerging high-growth neighborhoods before they become obvious to the broader market, and flags potential market corrections or bubbles. By embedding this predictive capability in the data preparation stage, every subsequent algorithmic component—from candidate retrieval to final ranking—operates with sophisticated market awareness rather than static property attributes. This transforms the entire recommendation pipeline from a basic property matching system into a comprehensive investment analysis platform that can adapt to changing market conditions and optimize for long-term portfolio performance.

A foundation for the Future House Price Model was developed by training it on historical data and implementing multiple prediction algorithms. Experiments were performed based on incorporating multiple listing service (MLS) data, search engine locations, and macroeconomic indicators, while also training the model on a dataset spanning years the last 10 years. The experiments showed that an initial comprehensive foundation was developed for accurate predictions by capturing long-term trends in the housing market. Additional data sources were incorporated, such as demographic information, local market trends, and property-specific attributes like proximity to amenities, and the impact of neighborhood characteristics, property age, and square footage on house prices. Furthermore, the prediction algorithms, Neural Net, long short-term memory (LSTM), autoregressive integrated moving average (ARIMA), and social media algorithm were analyzed and refined. Tests showed positive outcomes, with the expansion of historical data to the last 20 years providing a more solid foundation for capturing long-term trends.

The Future House Price Model was further improved by integrating real-time data and employing advanced time-series analysis techniques. Experiments were performed involved integrating additional data sources, such as real-time market data, economic indicators, or social media sentiment, and exploring advanced time-series analysis techniques specifically tailored for house price predictions. The interpretability of the models were enhanced through techniques such as SHapley Additive explanations (SHAP) values. The tests showed that the model's accuracy and relevance of predictions had improved through the integration of additional data sources and features.

The model, now capable of predicting seasonal variations in house prices using historical periodic data, was yet further improved using ensemble techniques, implementing continuous model updating, and establishing a feedback loop with users and real estate professionals. The experiments included utilizing ensemble techniques such as stacking or boosting to combine predictions from multiple algorithms, implementing automated data ingestion and retraining processes for continuous model updating, and gathering insights from users and real estate professionals to improve the model based on real-world feedback.

### Investment Recommendation Engine Embodiments

In some embodiments, a unique investment recommendation engine is provided, i.e., a ML Recommendation Engine. Specifically, an advanced system that matches investors to investment opportunities based on their risk-return preferences was created, utilizing quantitative and qualitative public and private data, along with customer behavioral data. Technological limitations due to the lack of pre-existing solutions in the private market asset investment space were overcome.

A foundation for real-estate recommendation system was created, focusing on risk-adjusted return scoring of properties and determining the risk appetite of investors. Experiments were performed based on the calculation of property risk-adjusted scores using the last 20 years of public Real Estate Investment Trust (REIT) data and the Sharpe ratio. A clustering model and data vector information were also used to determine investor risk and return objectives. Testing showed positive results, with property risk-adjusted scores and investor risk profiles successfully being determined. The accuracy and performance of the real-estate recommendation system was augmented in iterations. Experiments were performed for iterations that included the establishment of a feedback mechanism, the exploration of additional data sources, and the investigation of advanced risk modeling techniques. Mean, covariances, volatility, and Sharpe ratios are utilized as inputs, mapping risk scores to portfolio variance with a custom objective function. Sector penalties were applied to ensure proper allocation, and the platform's proprietary risk-matching algorithms are leveraged for portfolio optimization. The tests showed promising results, with the system now able to create more varied portfolios and better align investments with the customer's risk score and existing portfolio.

Portfolio optimization and recommendation accuracy were improved by implementing advanced portfolio optimization techniques, introducing a dynamic sector penalty, and incorporating real-time data. Experiments based on this approach involved maximizing the Sharpe ratio, implementing a global minimum variance approach, and considering other risk-adjusted performance measures. In addition, data on alternate investments are incorporated, including various asset classes such as office, industrial, retail, residential, and more.

The system was further improved through the use of advanced machine-learning techniques like deep learning or reinforcement learning for portfolio optimization and recommendation. The system allows for personalized investment strategies based on individual investor preferences, and ensures regulatory compliance.

All engineered features may be persisted in a feature store 1120 with versioning for reproducible training and online inference. The term “investor DNA” means numbers/categories that describe the investor (risk, liquidity horizon, ticket size, sectors). The term “deal DNA” means numbers/categories describing the deal (IRR, hold period, sponsor quality, minimum investment, asset class, ESG, etc.). Keeping these in the feature store 1120 ensures every algorithm reads the same “official” profile.

### Eligibility Filtering (Hard Constraints/Compliance Gate)

Eligibility filtering occurs before any scoring, and is deterministic and auditable. In some embodiments, a compliance engine reads an investor compliance profile and deal eligibility rule sheet. Filtering ules (applied before any scoring) include:
Jurisdiction allowed?
Accreditation status valid?
Minimum ticket≤investor's typical ticket?
Concentration limits (e.g., ≤10% of portfolio) satisfied?
Suitability constraints (e.g., “no high-leverage deals for low-risk investors”).

The result is a candidate set that can be defined as:

[symbol]

={d∈Deals|d passes all compliance/suitability rules for investor u}

Only the candidate set [symbol] proceeds to retrieval/scoring. If a deal fails any legal/suitability rule, it is removed. This provides that no illegal or unsuitable recommendation is ever shown.

### Deep Learning-Two-Tower Model 1132

In some embodiments, a two-tower deep retrieval model is used for candidate generation and ranking of eligible deals. The architecture comprises a first neural network (an investor tower) and a second neural network (a deal tower).

The investor tower receives as input eligibility-filtered investor features and a recent behavior sequence, and outputs an investor embedding eᵤ ∈ [symbol] ¹²⁸. The deal tower receives as input deal attributes and traction or engagement signals, and outputs a deal embedding e_{d} ∈ [symbol] ¹²⁸ A deep retrieval score between an investor u and a deal d is computed using a dot-product similarity function:

$${s}_{D L} ( u , d ) = {e}_{u}^{T} {e}_{d}$$

During training, the two-tower model is optimized using a contrastive softmax loss. Positive pairs correspond to investor-deal pairs that resulted in a commitment, while negative pairs are sampled from deals that were shown but not interacted with or committed to.

A representative formulation of the loss function is:

$${L}_{DL} = - log \frac{exp ( \frac{{e}_{u}^{T} {e}_{{d}^{+}}}{τ} )}{{\sum }_{{d}^{′} ∈ D} exp ( \frac{{e}_{u}^{T} {e}_{{d}^{′}}}{τ} )}$$

where:
d⁺ denotes a committed (positive) deal,
D denotes the candidate set comprising the positive deal and sampled negatives,
τ>0 is a temperature hyperparameter.

An equivalent positive-versus-negatives form may be written as:

$${L}_{DL} = - log \frac{exp ( {sim}_{pos} / τ )}{exp ( {sim}_{pos} / τ ) + {\sum }_{{d}^{′} ∈ N} exp ( {sim}_{n e g , {d}^{′}} / τ )}$$

$$where :$$

$${sim}_{pos} = {e}_{u}^{T} {e}_{{d}^{+}} ,$$

$${sim}_{neg , {d}^{′}} = {e}_{u}^{T} {e}_{{d}^{′}} for negative deals {d}^{′} ∈ N .$$

The training objective encourages embeddings of committed investor-deal pairs to be close in the embedding space, while pushing non-committed pairs farther apart.

At inference time, eligibility filtering is applied as a hard constraint prior to scoring. An eligibility gate evaluates investor compliance profiles and deal eligibility rules, including accreditation status, jurisdiction, suitability, minimum and maximum investment thresholds, KYC/AML flags, and concentration limits.

Let D_{eligible}(u) denote the set of deals that satisfy all eligibility and suitability constraints for investor u. All deals d∉D_{eligible}(u) are excluded from ranking.

For each eligible deal d∈D_{eligible}(u), the embeddings are computed as:

eᵤ=f_{θ}(investor features, behavior sequence), e_{d}=g_{φ}(deal features, traction signals) and the deep learning score is computed as:

$${s}_{DL} ( u , d ) = {e}_{u}^{T} {e}_{d}$$

Eligible deals are ranked in descending order of S_{DL}(u,d). The two-tower model produces a recommendation set defined as:

$$Rec ( u ) = {TopK}_{d ∈ {D}_{eligible} ( u )} {s}_{D L} ( u , d )$$

In some embodiments, K≥3.

### Illustrative Example

Consider an example investor with the following feature groups:
Investor features (examples only):
   Financial/Liquidity: liquid_net_worth=$2.0M, max_ticket=$150 k
   Risk: risk_tolerance=Medium,
   Objectives: target_IRR=12%, horizon_years=5
   Recent behavior sequence:
      viewed “multi-family real estate” four times
      clicked “preferred equity” twice
      skipped “high-volatility venture” three times

The investor tower encodes these inputs into an embedding vector eᵤ.

Deal features may include:
Deal features (examples only):
   Deal demographics: asset class, geography, sector
   Risk/return: target IRR, volatility bucket
   Requirements: minimum investment, eligibility tags
   Sponsor track record: MOIC, default rate, years operating
   Engagement and marketing: recent traction, email CTR, webinar attendance

The deal tower encodes these inputs into an embedding vector e_{d}.

Assume three candidate deals exist:
Deal A (eligible)
   accredited required=Yes
   min investment=$25 k
   geography allowed=Canada/US
   risk bucket=Medium
Deal B (ineligible): min investment=$250 k (exceeds investor max ticket)
Deal C (ineligible): geography allowed=US only (investor restricted to Canada)

After eligibility filtering:

$${D}_{eligible} ( u ) = \{ A \}$$

Assume a simplified 4-dimensional embedding space for illustration (actual systems may use 64-1024 dimensions):

$${e}_{u} = [ 0.6 , 0.2 , 0.1 , 0.4 ]$$

$${e}_{{d}_{A}} = [ 0.5 , 0.1 , 0.05 , 0.7 ]$$

The score for Deal A is:

$${s}_{DL} ( U , A ) = ( 0.60 ) ( 0.50 ) + ( 0.20 ) ( 0.10 ) + ( 0.10 ) ( 0.05 ) + ( 0.40 ) ( 0.70 ) = 0.605$$

Since only Deal A is eligible, it is recommended.

If Deal C were also eligible, with:

$${e}_{{d}_{c}} = [ 0.2 , 0.6 , 0.1 , 0.1 ]$$

$$then :$$

$${s}_{D L} ( u , C ) = 0.29$$

and the ranking would be:
1. Deal A (0.605)
2. Deal C (0.290)

In some embodiments with a large volume of deals, three or more independent scores may be determined for each candidate deal d∈ [symbol] .

Approach 1: Risk Score Matching—Matching Client Risk Scores with Deal Risk Scores 1134

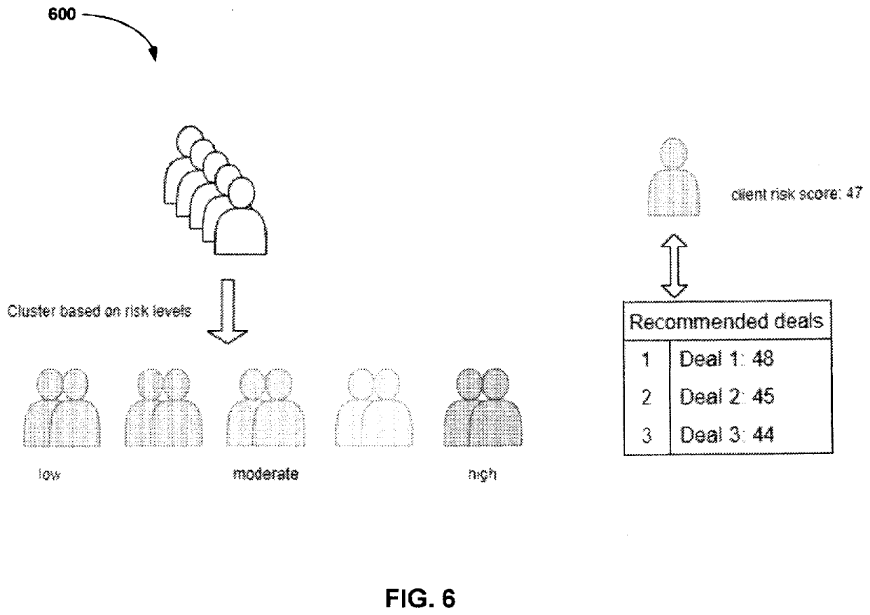

FIG. 6 illustrates an example of matching 600 client risk scores with transaction/deal scores, in accordance with some embodiments. Client may be matched with investment deals that align with their individual risk tolerance. I.e., client risk scores can be matched with transaction or deal risk scores. Each client's risk score may be clustered and matched with provided deal scores. For example, clients may be clustered based on their risk levels, then client risks score may be calculated. Then, clients may be matched with transactions by comparing client risk scores with the closest transaction/deal risk score.

In some embodiments, matching deals (or transactions) with individuals based on their risk score may include group deals based on their risk score into several (e.g., 5) categories, from very low risk to very high risk to match the categories of individuals' risk scores.

In some embodiments, matching deals (or transactions) with individuals based on their risk score may include match one deal per individual as: a. deal and individual in the same risk category; b. deal has the closest and lower risk score compared to the individual's risk score; c. if there is no deal with a lower risk score, then match the closest with higher risk score; or d. if there are no deals in that category, then do not recommend anything (e.g., Deal id is 0).

In some embodiments, matching deals (or transactions) with individuals based on their risk score may include checking if the matched deal exists in the Clicks or Invested deals. Clicks or Invested deals represent client interaction and may be considered as a list of customer “excitement” about the deal variables and includes, clicking invest button on the deal, actually creating a transaction to invest (or partially creating the transaction to invest), sending questions and follow-up email or set up deal specific meetings with sponsor and platform teams, attending deal specific events such as dedicated webinars or “ask-me-anything sessions” with deal issuers, metrics that measure engaging with the deal content such as time spent on reading deal details, and different sections of the deal content compared to median time.

In some embodiments, client clustering involves applying a K-Means clustering model and categorizing clients into clusters (e.g., 5 clusters): very low risk, low risk, moderate, high risk, very high risk. It should be noted that additional or fewer clusters may be used. Client risk scoring may comprise calculating risk scores based on the distances to the cluster centroids. Deal score alignment may comprise matching the calculated client risk scores with the closest provided deal risk scores.

The following shows an example of client scoring data:
Base Risk Score:
   Very low risk: 0
   Low risk: 20
   Moderate: 40
   High risk: 60
   Very high risk: 80
Individual Risk Score:
   Risk scores reflect the distances from the five centroids and the base risk of each cluster.

The individual risk score comprises the base score of a cluster added to the relative distance to the cluster.

Table 7 illustrates an example of preliminary deal risk score data:

TABLE 7
Preliminary Deal Risk Score Data

| User ID | User Risk | Deal Provided Risk | Deal ID |
|---|---|---|---|
| 23 | 91 | 83 | 17 |
| 148 | 80 | 81 | 25 |
| 974 | 95 | 81 | 25 |
| 1067 | 63 | 62 | 10 |
| 1160 | 93 | 83 | 17 |
| 1230 | 54 | 55 | 12 |
| 1239 | 40 | 48 | 22 |

For risk score matching, the calculated risk scores are aligned with the nearest corresponding deal preliminary risk scores, and recommended deals to investors based on the closest risk scored.

In some embodiments, a K-Means clustering model is used.

If a non-pretrained argument is passed, a new K-Means clustering model will be trained, saved and used for testing. Hyperparameters of the model may be adjusted in a function call.

If no argument is passed regarding the training, a pretrained model may be loaded. Recommendations for new users maybe obtained with a pretrained model.

In some embodiments, a model may comprise two or more primary models. For example, the clustering model for risk score calculation described above may be combined with the content-based filtering model also described below.

The clustering model groups clients based on their risk profiles. By analyzing the preprocessed client data, the model identifies clusters of clients with similar investment behaviors and risk tolerances. Each client is assigned a risk score based on the cluster to which they belong. The clients are then matched with the deals based on their risk score and the deals' risk scores.

The content-based filtering model recommends investment deals by calculating the cosine similarity between client profiles and available deals. The client profile is created based on their previous investment activities. The model then scores each deal based on its similarity to the client profile, and recommends the top N deals to each client.

In some embodiments, investors are clustered into a predefined number of risk groups using a K-Means clustering model applied to normalized investor risk-related features. In this example, five clusters are used:

TABLE 8
Risk Cluster Base Risk Scores

| Risk Cluster | Base Risk Score |
|---|---|
| Very Low Risk | 0 |
| Low Risk | 20 |
| Moderate Risk | 40 |
| High Risk | 60 |
| Very High Risk | 80 |

Each cluster has a centroid representing a characteristic risk profile.

Each deal is assigned a preliminary deal risk score, which may be derived from deal-level attributes such as volatility, leverage, asset class, duration, and sponsor risk.

For a given investor uwith risk score RiskScorey, the system selects a deal whose risk score is closest to the investor's risk score, subject to predefined matching rules.

In some embodiments, a normalized risk-alignment score s_{RS}(u,d) is computed as:

$${s}_{RS} ( u , d ) = 1 - \frac{\vert {RiskScore}_{u} - {RiskScore}_{d} \vert}{{R}_{m ax}}$$

where Rₘₐₓ is the maximum possible risk score range (e.g., 100).

### Example

For Investor u(risk=91) and Deal 17 (risk=83):

$${s}_{R S} ( u , 17 ) = 1 - \frac{\vert 91 - 83 \vert}{100} = 1 - 0.08 = 0.92$$

This produces a high-risk compatibility score.

A combined recommendation may be generated by calculating the overlap of results from both the clustering model and the content-based filtering model. If there is no overlap, results from one of the primary models (e.g., the content-based filtering results) could be used. If the client does not have content-based recommendations (i.e., the client is new and has not clicked or invested in any deals), the clustering recommendations could be used.

Two independent recommendation models will now be described. A clustering (risk-based) model involves grouping investors/clients into risk clusters, and recommends deals whose risk profiles match the investor/client's cluster. A content-based filtering model uses investor/client interaction history (clicks, investments), and recommends deals most similar to the investor/client's past behavior.

Each model produces its own ranked list of deals for a client. The overlap is the set of deals that appear in both lists. The overlap is calculated using set intersection. For a given client, i:

$${Overlap}_{i} = {C}_{i} ⋂ {B}_{i}$$

where:
Cᵢ=top N deals recommended by the clustering (risk) model; and
Bᵢ=top N deals recommended by the content-based model.

If the overlap set is empty, then recommendations from one primary model is used. In some embodiments, it is preferred to fallback (as described) to content-based filtering results.

To cold-start a client (no interaction data) where the client has no clicks or investments, content-based filtering cannot generate recommendations. In this situation, clustering (risk-based) recommendations may be used.

### Approach 2: Content Based Filtering 1136

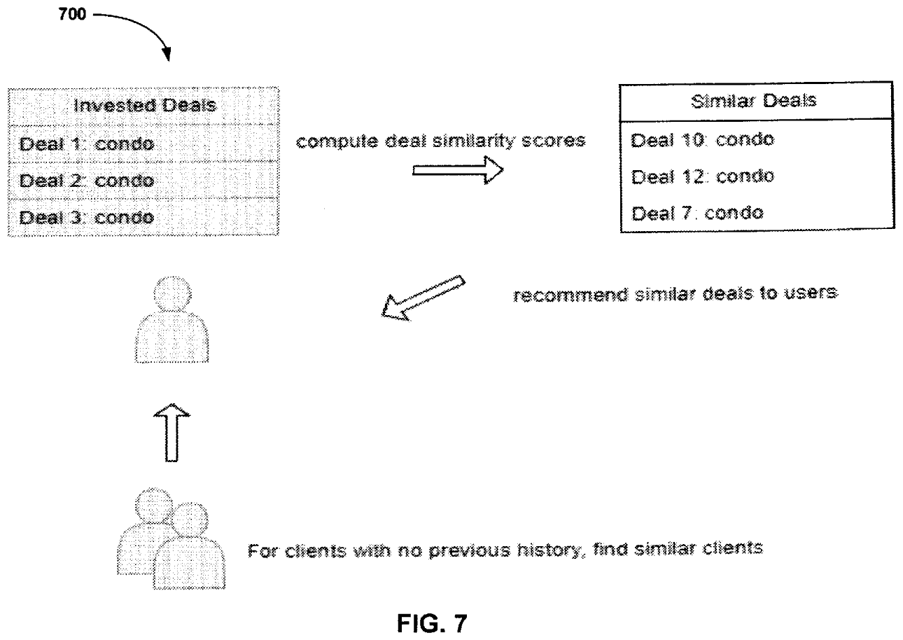

FIG. 7 illustrates an example of content-based filtering 700, in accordance with some embodiments. Matching deals (or transactions) with individuals based on their risk score may include a content-based recommender system working with data that the client provides, either explicitly (directly rating, risk preference) or implicitly (clicking on a link). Intuitively, similar deals may be recommended to clients who have invested those deals.

In some embodiments, the similarity scores may be calculated between each deal information. Based on previously invested deals, each user may be recommended similar deals. For clients with no previously invested history, their demographic information may be used to find similar users with similar investment history.

In some embodiments, content-based filtering includes identifying users with investment history, calculating similarity scores, and determining recommendations. Users with investment history may be identified by previous investments or “clicks” on “buy buttons” or other buttons on an investment desktop application or phone app. For each user's past investment history, this information may be transformed into a ML representation and compared to a set of existing investment deals. Features such as preliminary risk score, sponsor risk, returns deals, leverage ratios may be selected. In some embodiments, there may be a list of many variables (e.g., 178 variables) across: (1) macroeconomic variables such as gross domestic product (GDP)/Income, inflation, growth; (2) industry metrics for the investment or location metrics for a real estate deal such as vacancy rate in the geography; (3) deal level forecasts and deal industry level variables such as deal industry growth rate, deal industry competitive landscape, and scope for growth and market share; and (4) sponsor level metrics such as experience of the key operator's chief user experience officer (CXO) for the investment opportunity, track record, any legal issues in the past or current, social media analytics on the key sponsors. The variables may be analyzed against may years (e.g., the last 80 years) of public market data in comparable sectors/proxies to establish baseline, and then compared to similar data for the specific private deal.

Deal risks versus returns may be plotted based on similar performance in the public markets. By comparing these features, how similar the new deals are to the ones the client has previously invested in may be determined. Based on the similarity scores, user may receive recommendations regarding deals that are similar to their past purchased deals. If a user does not have any past investment history, the user may be matched with other clients through their demographic history to the user may be used to compare past transactions/deals of those other clients.

In some embodiments, creation of a user profile may comprise aggregating the invested deal and buy button clicks features of deals the client has interacted with.

In some embodiments, similarity calculation may comprise comparing the user profile with the deal feature vectors to determine similarity.

In some embodiments, generating recommendations may comprise recommending the top N deals with the highest similarity scores to the user.

Vector representation of user profiles may be created based on past invested deals and buy button clicks (i.e., user interaction). Table 9 shows an example of client investment behavior data.

TABLE 9
Client Investment Behavior Data

| User ID | Buy Button Clicks | Invested Deals |
|---|---|---|
| 90 | [4] | [4] |
| 118 | [4, 5, 7, 9, 10, 11, 12, 13, 14, | [4, 5, 12, 13] |
| | 18, 19, 24, 25, 27, 55, 86, 88, | |
| | 119] | |
| 148 | [1, 4, 9, 12, 17, 18] | [4, 17] |
| 974 | [4, 14, 15, 19] | [0] |
| 1067 | [4, 12, 13, 14, 17, 24, 25] | [0] |
| 1160 | [1, 4, 5, 7, 9, 10, 11, 12, 13, | [1] |
| | 14, 15, 16, 18, 19, 22, 24, 25, | |
| | 27] | |

Table 10 shows an example of transaction/deal data:

TABLE 10
Transaction Data

| | | | | | | | | Leverage |
|---|---|---|---|---|---|---|---|---|
| | Preliminary | | | | | | | Ratio |
| Deal | Risk | Deal | | Sponsor | Returns - | Returns - | | (Debt/ |
| ID | Score | Category | Sponsor | Risk | Deal | Section | . . . | Assets) |
| 4 | 35 | Condominium | BuyProperly | 6 | 11.80% | 15.16% | . . . | 0.10 |
| . . . | | | | | | | . . . | |

The vector representation of a user profile comprises:

$$( weight\_ 1 \times invested features ) + ( weight\_ 2 \times clicks features ) .$$

To recommend new deals, we calculate the similarity between the user profile created and the feature representation of all existing deals. In one example, the following equation may be used:

$$\begin{matrix}cosine similarity = SC ( A , B ) := cos ( θ ) \\ = \frac{A \cdot B}{‖ A ‖ ‖ B ‖} \\ = \frac{{\sum }_{i = 1}^{n} {A}_{i} {B}_{i}}{\sqrt{{\sum }_{i = 1}^{n} {A}_{i}^{2}} \cdot \sqrt{{\sum }_{i = 1}^{n} {B}_{i}^{2}}}\end{matrix}$$

Table 11 shows an example of similarity scores for different recommended deals.

TABLE 11
Similarity Scores for Recommended Deals

| User | Recommended | Similarity | Invested | Buy Button |
|---|---|---|---|---|
| ID | Deal ID | Scores | Deal | Click |
| 90 | 4 | 1.00 | 4 | 4 |
| | 55 | 0.32 | | |
| | 1 | 0.30 | | |
| | 2 | 0.30 | | |
| | . . . | . . . | | |

Feature vectors include investor vector vu (engineered investor DNA), deal vector va (engineered deal DNA), and the investor profile. The cosine similarity score is defined as:

$${s}_{CB} ( u , d ) = cos ( {v}_{u} , {v}_{d} ) = \frac{{v}_{u}^{T} {v}_{d}}{‖ {v}_{u} ‖ ‖ {v}_{d} ‖}$$

The CB measures how well the deal matches the investor's explicit preferences (risk band, sector, ticket size, etc.).

### Approach 3: Collaborative Filtering (CF) 1138

The model uses Alternating Least Squares (ALS) via Implicit or Spark ALS on the Investor-Deal Interaction Matrix. The interaction weighting (explicit) is set to:
Commitment (funded)→weight=10
Data-room view→weight=2
Download→weight=3
Skip→weight=−1 (negative signal)

Outputs and scores include:
Investor latent vector: pᵤ
Deal latent vector: q_{d}
CF score:

$${s}_{CF} ( u , d ) = {p}_{u}^{T} {q}_{d}$$

In some embodiments, the training frequency is performed in a nightly batch, versioned in a Model Registry. The CF learns what “similar investors” liked based on historical behavior and transactions.

A collaborative filtering recommender system may use client-items interactions and build a model based on a user's past behaviors and similar decisions made by other behaviors, including: analyzing past behavior, finding similar customers and making recommendations. Explicit ratings may be given to an item by the user. Implicit ratings may be inferred based on past purchases and clicks (user interaction).

When analyzing past behavior, deals a customer has clicked on or purchased may be reviewed. This data may be used to create an interaction matrix. Other customers who have similar behavior patterns (similar clicks or purchases) may be identified. In some embodiments, analyzing past behavior and finding similar customers are performed using a matrix factorization approach. A target customer may then receive a recommendation for deals that these similar customers have clicked on or purchased but the target customer has not interacted with yet. It should be noted that collaborative filtering uses customers' past behaviors (clicks and purchases), leverages the preferences of other customers with similar behaviors to make recommendations, and does not require detailed information about the deals themselves.

In some embodiments, a collaborative filtering workflow includes creating a user/deal interaction matrix (based on Buy Button Clicks & Invested Deals), performing matrix factorization and recommending deals.

The following is an example of an interaction matrix with rows representing users and columns representing deals:

### User/Deal Interaction:

$$\begin{matrix}[ [ 1. 0. 0. ⋯ 0. 0. 0. ] \\ [ 1. 1. 0. ⋯ 0. 0. 0. ] \\ [ 2. 0. 0. ⋯ 0. 0. 0. ] \\ ⋯ \\ [ 0. 0. 0. ⋯ 0. 0. 0. ] \\ [ 0. 0. 0. ⋯ 0. 0. 0. ] \\ [ 0. 0. 0. ⋯ 0. 0. 0. ] ]\end{matrix}$$

### Shape of Matrix: (265, 26)

Matrix factorization may include creating two matrices (one for User latent space and one for Deals latent space). These matrices capture user past behavior and users' similarities. Recommend deals for each user may be based on their past buys and similar users purchases.

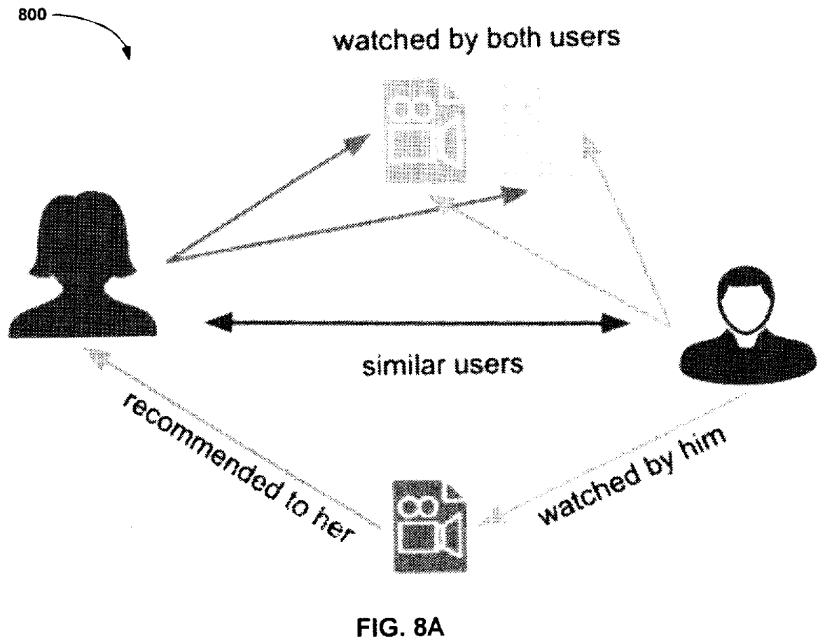

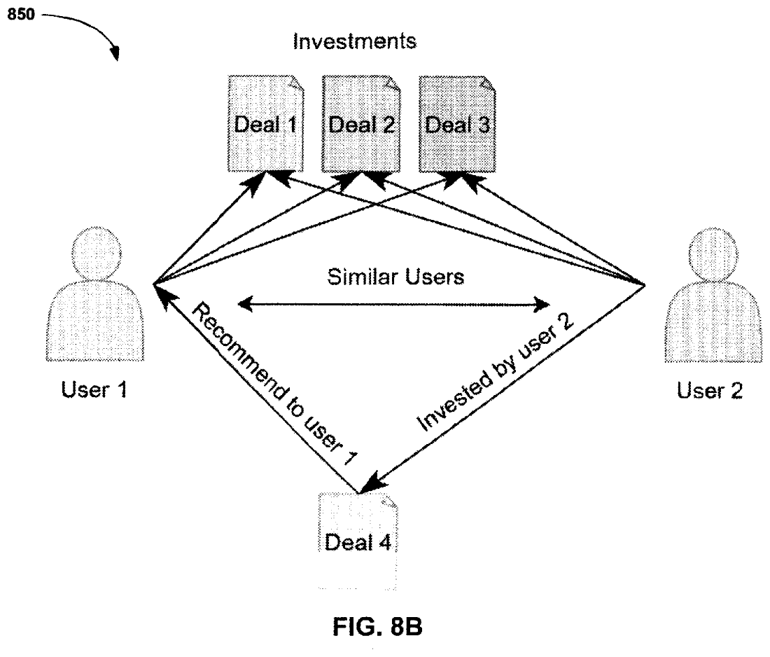

FIGS. 8A and 8B illustrate examples of collaborative filtering 800, 850, in accordance with some embodiments. In this example, similar users with a history of viewing similar videos are shown. If one of those similar users views a new video, then that video may be recommended to the other similar user.

In some embodiments, creating a client-deal interaction matrix comprises generating a matrix based on buy button clicks (user interaction clicks) and invested deals (past transactions). Ratios may be assigned to buy button clicks and invested deals. For example, a 1 to 3 ratio may be assigned. Other ratios may be used.

In some embodiments, performing matrix factorization comprises factorization and optimization. The interaction matrix may be factorized into two matrices: user latent feature and deal latent feature. Factorization may be optimized using and Alternating Least Square method.

In some embodiments, calculating scores for deals for each user comprises the dot product of deals latent feature matrix with a user's latent feature matrix, where the top N rated deals are used.

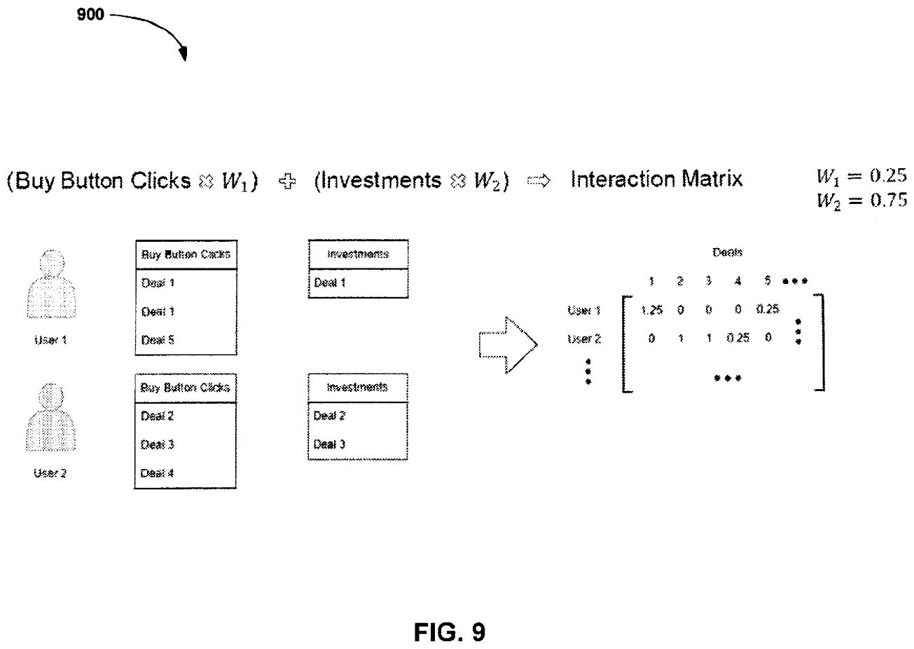

FIG. 9 illustrates an example of generation of a client-deal interaction matrix, in accordance with some embodiments. In this example, W₁ is set to a 0.25 and W₂ is set to 0.75 (i.e., a 1 to 3 ratio).

In some embodiments, the interaction matrix comprises:

$$( Buy Button Clicks \times {W}_{1} ) + ( Investments \times {W}_{2} ) .$$

Matrix factorization can be seen as breaking down a large matrix into a product of smaller ones. A matrix R with dimensions m×n can be reduced to a product of two matrices U and V with dimensions m×p and n×p respectively, where.

$$R = {U}^{T} \times V$$

R: User—Deal Interaction Matrix (m×n)
U: User Latent Factors (m×p)
UT: Transpose of U
V: Deal Latent Factors (n×p)
p: Latent Feature Dimensions
m: Number of clients
n: Number of deals

Alternating Least Squares may be used to minimize the sum of squared errors between the original matrix and the product of the two factorized matrices. First, matrices U and V may be randomly utilized. In each iteration: a) Fix U and solve for V; and b) Fix V and solve for U.

$${argmin}_{U , V} {\sum }_{\{ i , j \vert {r}_{i j} \neq 0 \}} {( {r}_{i , j} - {u}_{i} {v}_{j}^{T} )}^{2} + λ ( {\sum }_{i} {n}_{{u}_{i}} ‖ {u}_{i} {‖}^{2} + {\sum }_{j} {n}_{{v}_{j}} ‖ {v}_{j} {‖}^{2} )$$

Deals ratings may be calculated and a recommendation provided. To calculate a deals rating, a dot product is calculated between:
uᵢ: User i Latent Feature (1×p)
V: Deals Latent Feature (n×p)

$${R}_{i , *} = V \cdot {u}_{i}^{T}$$

R_{i,+}: Scores user i will give to each deal (n×1)

Deals in which the user has already invested may be disregarded. The remaining deals may be sorted based on the rating. Once sorted, the top N deals may be recommended (where N is an integer).

### Score Alignment and Normalisation

At this stage, multiple raw relevance scores are available for each eligible deal. In some embodiments, the scores include:
s_{DL}(u,d): deep-learning two-tower retrieval score,
s_{RS}(u,d): risk-based alignment score,
s_{CF}(u,d): collaborative filtering score, and
s_{CB}(u,d): content-based similarity score.

Because these scores are generated by different models and may lie on different numeric scales, they are normalized and aligned prior to fusion.

### Normalization (Per Model)

For each model m∈{RS, DL, CF, CB}, a normalized score \tilde{s}ₘ(u,d) is computed. Option A: Z-score normalization

$${\tilde{s}}_{m} = \frac{{s}_{m} - {μ}_{m}}{{σ}_{m}}$$

where μₘ and σₘ denote the mean and standard deviation of scores produced by model m. Option B: Min-max normalization to [0, 1]

$${\tilde{s}}_{m} = \frac{{s}_{m} - min ( {s}_{m} )}{max ( {s}_{m} ) - min ( {s}_{m} )}$$

In some embodiments, score calibration techniques such as isotonic regression or Platt scaling are applied to the normalized scores to correct systematic bias and improve probabilistic interpretability.

After normalization and optional calibration, all model scores are aligned to a shared semantic scale, typically [0, 1]. As a result, a value such as 0.8 carries a consistent interpretation across models. This alignment step is necessary because the underlying models are trained independently and produce scores that are not directly comparable in their raw form. Normalization and alignment ensure that subsequent score fusion is fair, interpretable, and stable.

The “Hybrid Model”—Explainable Fusion with ANFIS

In some embodiments, the hybrid model is not a separate standalone algorithm. It is the explainable fusion layer. It sits after score alignment/normalisation and before ranking. Its function is to combine multiple normalized relevance signals into a single, explainable composite score S_{final}.

### Fuzzy Input Variables

Table 12 provides examples of fuzzy input variables, their linguistic terms, and their derivation from normalized model outputs and engineered features.

TABLE 12
Fuzzy Variables

| Fuzzy Variable | Linguistic Terms | Input Derivation |
|---|---|---|
| RiskFit | Low, Medium, High | Normalised distance between investor risk |
| | | band and deal risk profile. |
| LiquidityFit | Illiquid, Medium, Liquid | Normalised gap between liquidity needs and |
| | | hold period. |
| TicketFit | Too Small, Adequate, | Ratio of deal minimum ticket to investor |
| | Sufficiently Large | typical ticket size |
| SponsorQuality | Weak, Average, Strong | Scaled sponsor track record score |
| StrategyMatch | Misaligned, Partial, Aligned | Overlap of preferred sectors with deal |
| | | sector. |
| EngagementIntent | Low, Medium, High | Intensity of recent investor portal activity like |
| | | clicks and dwell time |
| ColdStartConfidence | Low, Medium, High | Availability and strength of behavioral |
| | | signals for the investor |

Each variable may be fuzzified using membership functions (triangular or Gaussian).

### Rule Base (Examples)

In some embodiments, the following rules may be applied:
1. IF RiskFit is High AND LiquidityFit is High AND SponsorQuality is Strong THEN FinalScore is VeryHigh.
2. IF TicketFit is Too Small OR StrategyMatch is Misaligned THEN FinalScore is Low.
3. IF EngagementIntent is High AND ColdStartConfidence is High THEN FinalScore is High.
   In some embodiments, the rule base contains approximately 30 to 50 rules, though more or fewer may be used.

### ANFIS Training Loss (Binary Cross-Entropy)

An example of ANFIS training loss will be explained.

In some embodiments, the ANFIS model is trained using a binary cross-entropy loss function. Let:

$$\hat{y} ∈ ( 0 , 1 )$$

denote the ANFIS output for an investor-deal pair, interpreted as a probability of commitment, and

$$y ∈ \{ 0 , 1 \}$$

denote the observed historical outcome, where 1 indicates a commitment and 0 indicates no commitment.

The per-example loss is defined as:

$${L}_{ANFIS} = - [ y log ( \hat{y} ) + ( 1 - y ) log ( 1 - \hat{y} ) ]$$

During training, the ANFIS model adjusts:
membership function parameters (e.g., centers and widths), and
consequent parameters associated with fuzzy rules.

The ANFIS model therefore functions as a data-adaptive yet interpretable fusion mechanism that produces explainable outputs grounded in human-readable rules.

### Ranking, Presentation, and Robotic Investment

In some embodiments, the following steps may be performed in ranking:

### 1. Ranking

Eligible deals in the candidate set Care ranked in descending order of the final score S_{final} (u,d).

### 2. Top-K Selection

The top Kdeals (typically K=3) are selected and returned to the user interface.

### 3. Explanation Generation

The system surfaces the most influential fuzzy rules and contributing variables (e.g., High RiskFit, Strong SponsorQuality) to provide transparent explanations.

### 4. Automated Investment Option (Optional)

If the investor opts in, the system constructs a portfolio allocation plan subject to predefined constraints, including:
   a) maximum concentration per deal (e.g., ≤5%),
   b) liquidity reserve requirements, and
   c) diversification across asset classes.

The allocation plan may be computed using constrained optimization techniques, such as linear programming, with the ranked deal list as input. All ranking, explanation, and allocation operations occur after eligibility gating, thereby ensuring that investors are never presented with or able to invest in non-compliant or unsuitable deals.

### Long-Term Optimisation: Reinforcement Learning-Contextual Bandit

In some embodiments, the recommendation system applies a contextual bandit decision layer as a final layer to choose a subset of investment opportunities from a pre-scored and eligibility-filtered candidate set. The contextual bandit operates after suitability filtering, scoring, and explainable fusion, and immediately prior to presentation in the user interface. The contextual bandit receives investor context and deal attributes and selects a limited number of deals to present, balancing expected relevance with controlled exploration to improve future recommendations.

In some embodiments, after generating a ranked list of investment opportunities based on suitability and relevance scores, the system applies a contextual bandit model to select a subset of opportunities to present to a client. The contextual bandit receives contextual information associated with the client and evaluates a set of candidate investment opportunities that satisfy eligibility and risk constraints. Based on the contextual information and historical interaction feedback, the bandit model selects a limited number of investment opportunities that balance expected relevance with controlled exploration. Client interactions with the selected opportunities are subsequently used to update the bandit model for future recommendation decisions. For example, the system may then determine a final relevance score for each deal using suitability rules, deal quality scoring, behavioral models, and/or deep learning models. The system may then select the top K ranked deals (e.g., K=50). This step ensures all candidate deals are already compliant and suitable.

In some embodiments, the system first generates a ranked list of eligible investment opportunities based on suitability rules, risk-based scoring, collaborative filtering, content-based similarity, deep-learning retrieval, and ANFIS fusion. From this ranked list, a safe candidate set is constructed.

Let:
C denote the set of all deals,
C_{eligible} ⊂C denote deals that satisfy eligibility and compliance constraints, and
S⊆C_{eligible} denote the top-N deals ranked by ANFIS fusion.

The contextual bandit samples only from the safe set S, ensuring that non-compliant or unsuitable deals are never presented.

The contextual bandit observes a context that may include:
Investor risk profile or risk cluster
Investor engagement level or recent activity
Session intent signals (recent clicks, time spent)
Investor score or tier Market or platform state
Each action corresponds to selecting a specific deal from the candidate set.
The bandit selects actions sequentially or jointly to form a final recommendation set (e.g., 3 deals).
The system observes investor feedback such as:
   Clicks
   Time spent
   Watchlist actions
   Webinar registrations
   Investment commitments
The bandit model updates its internal parameters to improve future selection decisions.

In some embodiments, long-term optimization may be used, specifically, contextual bandit or reinforcement learning. The following components may be defined:
State sₜ Investor context: cash balance, recent deposits, accreditation status, browsing intent (e.g., “Green Energy” filter active).
Action aₜ Select subset of 3 deals from safe set S (top-N ANFIS-ranked eligible deals).
Reward rₜ Weighted sum of: CommitmentReward (log-scaled amount), EngagementReward (+1 download, −0.5 skip), DiversificationPenalty, RegretPenalty (post-commitment under-rt performance signals).

The method of Contextual Multi-Armed Bandit (CMAB) using Thompson Sampling or Linear UCB may be used.

### Feedback Loop and Model Lifecycle

In some embodiments, the following steps may be performed to provide a feedback loop and model lifecycle that provides continuous learning and auditability:
1. Capture signals
   Explicit: commitment amount, time-to-commit, repeat investment
   Implicit: dwell time, download, skip, bounce rate
2. Data ingestion: append signals with timestamps into Data Preparation pipeline.
3. Retraining schedule
   CF, Content, Two-Tower, ANFIS: retrain weekly (or trigger when >5% new interactions)
   Bandit policy: update daily
4. Model registry: store versions with training snapshot, hyper-parameters, compliance audit tags.
5. A/B testing & guardrails: shadow traffic rollout; monitor CTR (click through rate), conversion, compliance incidents before promotion.

### Loss Functions and Hyper Parameter Tuning

Loss functions are used for training deep learning components, including the two-tower retrieval model and the ANFIS fusion model. A loss function measures prediction error, and training iteratively adjusts internal model parameters to minimize the loss.

As defined above, the two-tower retrieval model is trained using a contrastive softmax loss that encourages embeddings of committed investor-deal pairs to be close in the embedding space, while pushing embeddings of non-committed pairs farther apart. In probabilistic form, the conditional probability of a deal dgiven an investor umay be defined as:

$$p ( d \vert u ) = \frac{exp ( sim ( {e}_{u} , {e}_{d} ) / τ )}{{\sum }_{{d}^{′} ∈ D} exp ( sim ( {e}_{u} , {e}_{{d}^{′}} ) / τ )}$$

where:
sim (eᵤ, e_{d}) denotes a similarity function (e.g., dot product),
τ is a temperature hyper-parameter, and
Ddenotes a candidate set including positive and negative samples.

The corresponding loss function is defined as:

$${ℒ}_{DL} = - log p ( {d}^{+} \vert u )$$

where d⁺ denotes a committed (positive) deal.

As defined above, an ANFIS loss (binary cross-entropy) was provided:

$${ℒ}_{ANFIS} = - [ y log ( \hat{y} ) + ( 1 - y ) log ( 1 - \hat{y} ) ]$$

where ŷ∈(0,1) is the ANFIS output interpreted as a probability of commitment, and y∈{0,1} is the observed historical outcome.

Table 13 shows Hyper-parameter tuning for two-tower loss.

TABLE 13
Hyper-parameters for two tower deep learning model

| | | Typical | How the best parameter is |
|---|---|---|---|
| Hyper-parameter | What it controls | search space | selected |
| Embedding dimension | Model capacity vs. | 32-512 | Grid-search; best validation |
| (64/128/256) | overfitting | | AUC |
| Temperature τ | Softmax sharpness | 0.05-1.0 (log) | Random search; maximise top- |
| | | | K precision/recall |
| Negatives per positive | Strength of | 1-20 | Increase until validation loss |
| K_{neg} | contrastive signal | | plateaus (often 5-10) |
| Learning rate | Gradient update step | 10⁻⁵-10⁻³ | Scheduler; fastest stable |
| | size | | improvement |
| Weight decay (L2) | Regularisation | 0-10⁻³ | Lowest validation loss without |
| | | | harming AUC |

In some embodiments, hyper-parameter selection for the two-tower deep learning model begins by partitioning historical investor-deal interaction data into separate training, validation, and test sets, for example using a seventy-fifteen-fifteen split, to enable unbiased model evaluation. The system then conducts a hyper-parameter search using the validation set to evaluate candidate configurations, including embedding dimensionality, learning rate, temperature parameters, and negative sampling ratios. During training, early stopping criteria are applied based on validation loss to prevent overfitting and to improve generalization. Among the evaluated configurations, the system selects the configuration that optimizes one or more business-relevant performance metrics, such as Recall@K or area under the receiver operating characteristic curve (AUC-ROC). Once selected, the configuration is frozen and stored in a model registry together with associated metadata, including random seeds, library versions, and training data snapshots, thereby enabling reproducible deployment, monitoring, and auditability.

Table 14 shows Hyper-parameter tuning for ANFIS loss:

TABLE 14
Hyper-parameter tuning for ANFIS loss

| | | Typical | |
|---|---|---|---|
| Parameter | What it does | range | Tuning approach |
| Number of fuzzy rules | Complexity vs | 10-100 | Smallest set achieving target |
| | interpretability | | validation log-loss |
| Membership function | Sharpness of | 0.1-2.0 | Grid-search; minimise validation |
| widths | Low/Med/High transitions | (scaled) | loss while keeping rules few |
| Learning rate (neal | Speed of consequent | 10⁻⁵-10⁻² | Random search; stable fastest |
| component) | adaptation | | loss reduction |
| Regularisation weight | Prevents overfitting and | 0-10⁻³ | Lowest validation loss |
| | drift | | preserving sparsity |

The workflow for hyper-parameter tuning for ANFIS loss includes i) training/validation/testing split data, ii) search, iii) early stop, iv) choose lowest validation BCE with manageable rule base (e.g., ≤30 active rules), and v) freeze. In some embodiments, hyper-parameter tuning for the ANFIS model begins by splitting historical interaction data into training, validation, and test subsets to ensure unbiased evaluation. The system then performs a hyper-parameter search over candidate configurations, including the number of fuzzy rules and membership function parameters, while monitoring performance on the validation set. Early stopping criteria are applied to prevent overfitting by terminating training when validation loss no longer improves. From the evaluated configurations, the system selects the configuration that achieves the lowest validation binary cross-entropy loss while maintaining a manageable and interpretable rule base, for example by limiting the number of active fuzzy rules to approximately thirty or fewer. Once selected, the trained ANFIS model is frozen and versioned, and the associated parameters and metadata are stored to support reproducible deployment and auditability.

Once recommendations are determined using the above teachings, they are returned to the client web application 128, and user interaction events (i.e., investor behavior) are captured and ingested into a data engineering pipeline (for example as part of the client data collection unit 121 or a separate data ingestion and processing system stored in memory 108). The ingested data is used to update feature representations and retrain models, thereby forming a continuous feedback loop. In some embodiments, this training occurs as part of the AI/ML processing unit 126 or a separate model training and feature storage system stored in memory 108.

In some embodiments, this disclosure describes a computer-implemented method and system in which a client application submits a user profile to an application programming interface (API) that orchestrates user identification, recommendation generation via a saved machine-learning model, presentation of recommendations to the client, and persistence of the generated recommendations for subsequent retrieval and reuse.

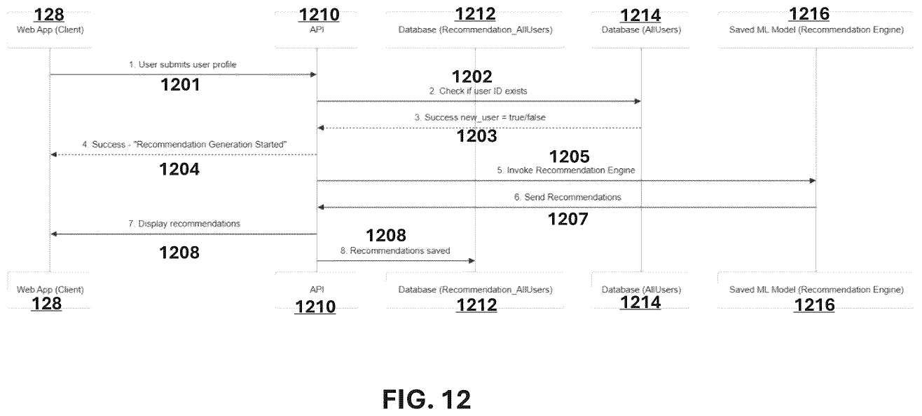

FIG. 12 illustrates, in a sequence diagram, an example of API-Driven Recommendation Generation and Persistence Flow 1200, in accordance with some embodiments. A client (i.e., investor) submits a user profile to the API 1210. A web-based client application (WebApp) 128 transmits a user (i.e., investor) profile payload to the API 1210. The payload may include a user identifier (i.e., investor identifier) and one or more attributes associated with the user/investor (e.g., demographic attributes, stated preferences, account settings, objectives, risk preferences, interaction history, or other features used for personalization). The API 1210 receives the request and begins a recommendation-generation workflow.

The API 1210 then validates 1202 user existence in the user database 1214. Upon receipt of the user profile, the API 1210 issues a database query to a UserDatabase to determine whether the submitted user identifier already exists. This verification step enables the system to branch into new-user initialization logic versus existing-user enrichment logic.

The user database then returns 1203 a status indicating a new user. The UserDatabase 1214 returns a response to the API 1210 indicating that the user identifier is not present and the user is classified as a new user (e.g., new_user=true). In certain embodiments, this status may also trigger additional actions (such as creating an initial user record or applying a default feature vector), although the primary function in this step is to provide the API 1210 with a user-status determination.

The API 1210 then acknowledges an initiation to the WebApp 128. The API 1210 returns 1204 an acknowledgement message to the client indicating that recommendation generation has been started (e.g., “Recommendation Generation Started”). This response may be used to update the client user interface immediately, reduce perceived latency, and allow asynchronous or near-real-time generation in subsequent steps.

The API 1210 then triggers the saved ML model to generate recommendations. After confirming user status, the API 1210 sends 1205 a request to a SavedMLModel component 1216 (which may be a deployed model endpoint, a containerized inference service, or a model registry-backed serving layer). The API 1210 provides the relevant user feature representation (derived from the submitted profile and/or defaults for new users) and requests generation of one or more recommended products, assets, or opportunities.

The saved ML model 1216 then returns personalized recommendations to the API. The SavedMLModel executes inference using the received user feature representation and produces a ranked set of personalized recommendations. The model 1216 returns 1206 these recommendations to the API 1210, optionally including associated metadata such as ranking scores, confidence values, explanations/features used, category labels, and/or eligibility attributes.

The API 1210 then delivers 1207 recommendations to the WebApp 128 for display. The API 1210 forwards the personalized recommendations to the WebApp (Client) 128. The WebApp 128 renders the results to the user, such as in a ranked list, grid, carousel, or other UI presentation format. This step enables user interaction (e.g., clicks, saves, dismissals), which may be logged for future model improvement.

The API 1210 then persists recommendations to a recommendation database for future use. In addition to returning the recommendations to the WebApp 128, the API 1210 stores 1208 the generated recommendations in a RecommendationDatabase 1212. Persisted data may include the user identifier, timestamp, recommended item identifiers, ranking order, model version identifier, feature snapshot identifier, and scoring metadata. Storing the generated recommendations enables subsequent retrieval without recomputation, supports auditing and traceability (including IP-related provenance of model outputs), improves performance, and provides a historical record of what was recommended at a given time. It should be noted that all databases described herein may be one of the databases 112 shown in FIG. 1.

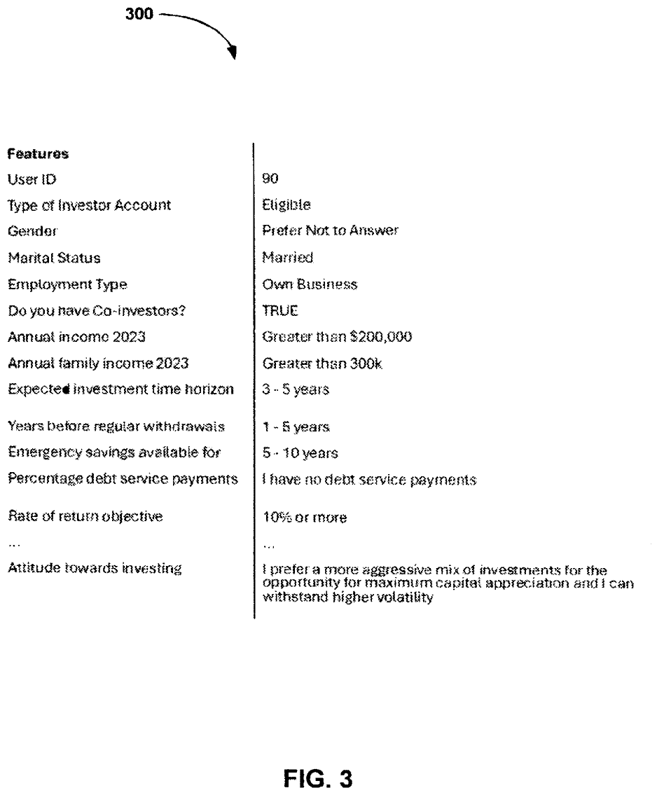

FIG. 3 illustrates an example of a client dataset 300, in accordance with some embodiments. In this example, investor features include UserID, type of investor account, gender, marital status, employment type, co-investors, annual income, annual family income, expected investment time horizon, years before regular withdrawals, amount of time emergency savings are available, percentage of debt service payments, rate of return, . . . , and attitude towards investing. Other investor features (not shown) may be included to provide a risk score for each investor registered in the system. In some embodiments, the client dataset 300 further includes eligibility and compliance attributes, accreditation status, investment objectives, liquidity needs, prior investment activity, and interaction signals. The client dataset 300 is processed to generate investor feature vectors and one or more investor risk scores, which are used in downstream operations including compliance gating, clustering, candidate retrieval, scoring, ranking, and recommendation generation.

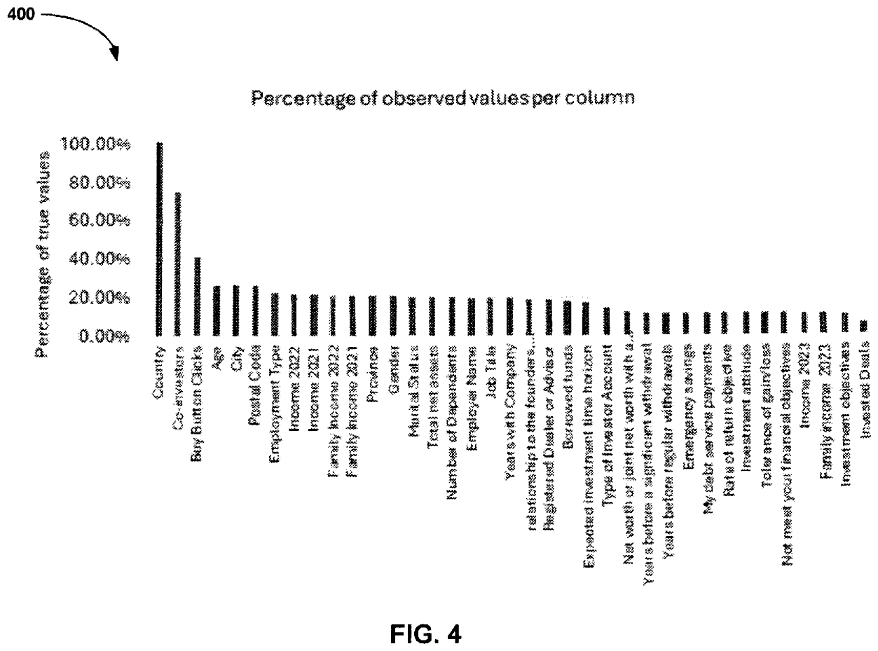

FIG. 4 illustrates an example of a chart 400 showing percentage of true values by percentage of observed values per column, in accordance with some embodiments. An example of an investor profile information is shown, including country, co-investor, number of buy button clicks, age, city, postal code, employment type, income for several years, family income for several years, province, gender, marital status, total net assets, number of dependents, employer name, job title, . . . , investment objectives, and invested deals. The chart 400 shows, for each respective data column, a proportion of values that evaluate to true relative to a total number of observed (non-missing) values in that column. In some embodiments, a value evaluates to true when a corresponding eligibility condition, validation rule, or feature availability requirement is satisfied. The chart 400 thereby provides a column-wise representation of data completeness and rule satisfaction across investor profile attributes, while excluding unobserved or missing values from the calculation. In some embodiments, the chart 400 is used to identify sparsity, bias, or feature reliability prior to downstream processing, including compliance gating, feature engineering, candidate retrieval, or recommendation scoring.

In some embodiments, feature selection includes the removal of unrelated features and those too complex to handle right now (such as city, postal code, job title, company, etc.). In one example, 28 out of 39 features were selected. For any missing data, investor profiles were retained with minimal missing values (approximately 600 profiles) and the remaining data was filled in using either the average value or the categorical label ‘unknown’. Feature engineering includes encoding categorical responses based on risk preference hierarchy. For example, users profiles may include information regarding:
What would you do if you cannot meet your financial objectives without assuming additional risk?
   Unknown→average
   Keep the same risk level that meets my tolerance and save more money and perhaps delay my time horizon to meet my goals→1.
   I may not be able to save more, but want to meet my goals and time horizon, so therefore I am willing to take some additional risk→2.
   I may be willing to save more and take on more risk to increase my opportunity to reach my goals→3.
   I am willing to increase my risk significantly to have the best opportunity to achieve my goals→4

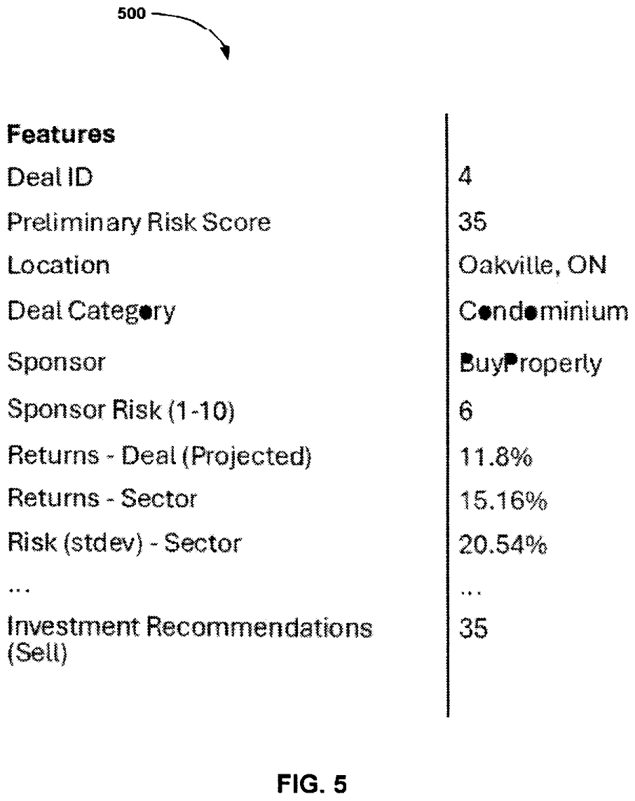

FIG. 5 illustrates an example of a deal information dataset 500, in accordance with some embodiments. In this example, features of the deal include deal ID, preliminary risk score, location, deal category, sponsor, sponsor risk, returns-deal (projected), returns-sector, risk (stdev)—sector, . . . , investment recommendations (sell). In some embodiments, the deal information dataset 500 further includes additional deal attributes such as minimum investment amount, investment time horizon, asset class, deal structure, funding stage, eligibility constraints, and historical performance metrics. The deal information dataset 500 is used to generate deal feature vectors for downstream processing, including compliance validation, risk alignment, candidate retrieval, scoring, ranking, and recommendation generation. In some embodiments, one or more fields within the deal information dataset 500 are derived, normalized, or transformed prior to use in machine learning or rule-based models

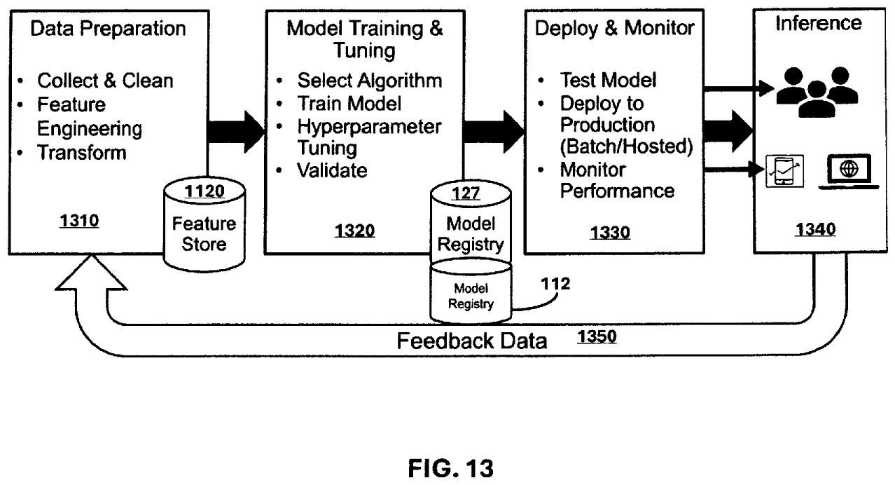

FIG. 13 illustrates an example of recommendation system operations 1300, in accordance with some embodiments. The training involves data 1310, model training and tuning 1320, deployment and monitoring 1330 and inference 1340. Feedback data 1350 may be sent back to data preparation to provide a feedback loop.

### Data Preparation 1310

Before recommending an investment, the system organizes the complex financial data of both investors/clients and investment opportunities called deal. As described above, the system performs data aggregation, data balancing, feature engineering, and a feature store.

Data Aggregation: The system ingests data from disparate sources: CRM logs (investor calls), Transaction Systems (past investments), and the Deal Database (asset details).

Data Balancing: Private markets are sparse. The system balances the dataset to ensure it doesn't just recommend the single “hottest” deal to everyone, but finds niche matches for specific strategies.

Feature Engineering: Raw data is converted into “Financial DNA” including:
Investor Features: Risk tolerance, liquidity needs, accredited status, preferred sectors (e.g., “Bullish on Biotech”), and average ticket size.
Deal Features: IRR targets, hold period, sponsor track record, asset class (Real Estate vs. VC), and minimum investment requirements.

Feature Store: These detailed financial profiles are stored to train the model on historical patterns.

### Model Training and Tuning 1320

This is where the engine learns to match investors and deals, involving matching method selection, model training and model registry. Matching method may be selected to predict the deal recommendations. For example, model training involves the model analyzing historical investment behavior to learn latent patterns. It learns patterns such as “Investors who committed to Commercial Real Estate in Texas often commit to Multi-family housing in Florida.” Model registry: Once a model is validated (and confirmed to comply with compliance rules), it is versioned and saved as the Hosted Model.

### Deployment and Monitoring 1330 and Inference 1340

This occurs in real-time when an investor logs into the investment portal. For example, an investor logs in to view open opportunities. The system retrieves real-time context. Has this investor recently deposited cash? Did their accreditation renew today? Are they currently browsing “Green Energy” deals? As an inference 1340 (the endpoint), the web application sends the investor's profile to the hosted model. The model instantly filters out ineligible deals and ranks the remaining open deals by top N (e.g., three) recommended deals.

This results in the investor being presented with a curated dashboard: “Top 3 Recommended Deals for You” rather than a generic list of all available deals. It also explains why these deals are recommended for the investor. In some embodiments, the investor is also provided an option to choose robotic investment based on the recommendation system, where the chosen investment fund is invested in the recommended deals by the system. If the investor has opted for robotic or automatic investment, the system may additionally present periodic analyses explaining why certain deals outperformed or underperformed over time.

The feedback loop 1350 improves recommendation quality over time. The loop may include explicit signals where, if an investor commits capital, then that is the strongest positive signal. The loop may also include implicit signals where, if an investor views a data room of the web application but leaves without downloading the document, that is a negative signal. This interaction data flows back to data preparation 1310 creating a cycle. The model learns and adjusts future recommendations accordingly.

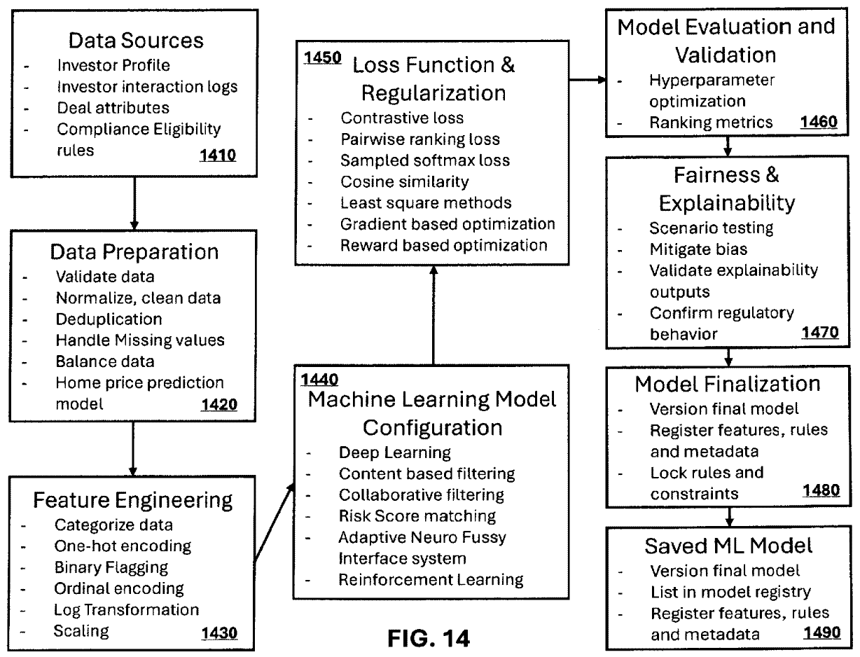

FIG. 14 illustrates, in a high-level flowchart, an example of an offline recommendation model generation operations phase 1400 for model formation and training, in accordance with some embodiments. The offline phase 1400 describes the asynchronous process of generating a deployable machine-learning artifact. In some embodiments, a compliance feedback loop is provided by the integration of “compliance/eligibility rules” into the feature engineering and validation steps, ensuring that the machine-learning model does not recommend legally non-compliant financial products.

Ingestion and Normalization (Steps 1410-1420): The process initiates at block 1410, where the system ingests a plurality of data sources, including user profiles, interaction logs (clickstream data), transactional history (investments), and specific item/deal attributes. Notably, the system also ingests compliance and eligibility rules essential for regulated environments. At block 1420, this raw data undergoes normalization, cleaning, and validation, which includes schema verification, deduplication, and the handling of missing values to ensure data integrity.

Feature Engineering (Step 1430): Proceeding to block 1430, the system constructs feature representations. Investor Features are derived including identity, financial liquidity, risk tolerance, investment objectives, and temporal behavior sequences. Deal Features are derived including demographics, risk/return profiles, capital requirements, sponsor track records, and engagement metrics.

Machine Learning Model Configuration 1440: At block 1440, a multi-component recommendation architecture is configured to process the constructed interaction representations. In some embodiments, the architecture comprises a deep-learning retrieval model implemented as a two-tower neural network, wherein a first tower embeds investor features and a second tower embeds deal features to generate candidate relevance scores for investor-deal pairs.

In some embodiments, the architecture further comprises one or more risk scoring models configured to calculate investor risk scores, deal risk scores, and investor-deal risk compatibility scores. Risk scoring is performed using feature categories including financial capacity, affordability, liquidity needs, withdrawal expectations, risk tolerance, behavior in market stress, investment time horizon, and deal volatility or uncertainty metrics. The resulting risk scores represent risk alignment constraints and are generated prior to or in parallel with preference-based modeling.

In some embodiments, the architecture further comprises one or more content-based filtering models configured to compute similarity scores between investor profiles and deal attributes. Content-based filtering is applied using feature categories including investment objectives, return expectations, sector preferences, geographic preferences, investment time horizon, sophistication and experience indicators, sponsor trust preferences, and deal structural characteristics. These models generate preference-alignment scores based on explicit investor intent and stated or inferred attributes.

In some embodiments, the architecture further comprises collaborative filtering models constructed using investor-deal interaction matrices derived from historical transactions and engagement signals. Collaborative filtering utilizes feature categories including engagement level, decision intent signals, social proof sensitivity, momentum sensitivity, marketing responsiveness, communication channel preference, education engagement, and prior co-investment behavior. These models capture latent behavioral patterns across similar investors and deals.

In some embodiments, the outputs of the risk scoring models, content-based filtering models, and collaborative filtering models are provided as inputs to a neuro-fuzzy inference component, including an Adaptive Neuro-Fuzzy Inference System (ANFIS), which performs fuzzy reasoning and rule-based fusion to generate interpretable investor-deal alignment scores. In some embodiments, a reinforcement learning component operates downstream of the ANFIS component to select a final subset of recommendations subject to exploration, performance, and compliance constraints.

Loss Functions (Block 1450): At block 1450, the configured model components are trained using component-specific loss functions and regularization (optimization) objectives. In some embodiments, the two-tower deep-learning retrieval model is trained using retrieval-oriented loss functions, including contrastive loss, pairwise ranking loss, or sampled softmax loss, with the objective of maximizing similarity between observed investor-deal interactions and minimizing similarity for non-interacting pairs.

In some embodiments, the content-based filtering models are trained using similarity-based or supervised objectives, including cosine similarity maximization, distance minimization, or regression loss, with the objective of learning accurate preference alignment between investor features and deal attributes. In some embodiments, the collaborative filtering models are trained using matrix factorization or latent factor techniques optimized via reconstruction loss, implicit feedback loss, or regularized least-squares objectives, with the objective of capturing latent behavioral patterns from historical interaction data.

In some embodiments, the risk scoring models are trained using supervised classification, regression, or ordinal loss functions, with objectives including prediction of risk levels, assignment of risk bands, and estimation of investor-deal risk compatibility. In some embodiments, the ANFIS component is trained using hybrid learning techniques combining least-squares estimation and gradient-based optimization to minimize output error while preserving rule interpretability.

In some embodiments, the reinforcement learning component is trained using reward-based objectives, including maximizing engagement, transaction completion, or long-term investor utility, subject to safety constraints, exploration limits, and regulatory compliance requirements.

Model Evaluation and Validation 1460: During the model evaluation and validation stage, the trained model components and fused outputs are evaluated to determine whether they satisfy predefined performance and stability requirements. In some embodiments, hyperparameters associated with the retrieval models, content-based models, collaborative filtering models, risk scoring models, and fusion logic are optimized based on offline evaluation results. The system evaluates recommendation quality using ranking-based metrics, including measures of relevance, ordering quality, and coverage across investor and deal populations. The evaluation stage ensures that the model produces consistent, accurate, and stable ranking outputs prior to further assessment.

Fairness and Explainability 1470: During the fairness and explainability 1470 stage, the system performs scenario testing to evaluate model behavior under varying market conditions, investor profiles, and deal availability states. In some embodiments, the system analyzes recommendation outputs to detect and mitigate bias, including over-exposure of certain deals, under-representation of specific investor cohorts, or sensitivity to popularity effects. The system further validates explainability outputs generated by the fusion and inference components to ensure that the underlying feature contributions and decision logic are consistent with the model behavior. In some embodiments, the system confirms that recommendation outputs and explanations comply with regulatory and suitability requirements, including risk alignment and eligibility constraints.

Model Finalization 1480: During the model finalization 1480 stage, the system produces a finalized version of the trained recommendation models and associated fusion logic. In some embodiments, model parameters, rules, and constraints are locked to prevent unintended modification prior to deployment. The system registers the final configuration, including feature definitions, inference rules, and constraint settings, to ensure reproducibility, auditability, and governance of the finalized model.

Saved Machine Learning Model 1490: During the saved machine learning model 1490 stage, the finalized model artifacts are serialized and stored as a saved model object. In some embodiments, the saved model is versioned and listed in a model registry to enable controlled access, lifecycle management, and rollback. The system registers associated metadata, including feature schemas, rule definitions, training context, and evaluation results, thereby making the saved model available for use during an online recommendation phase.

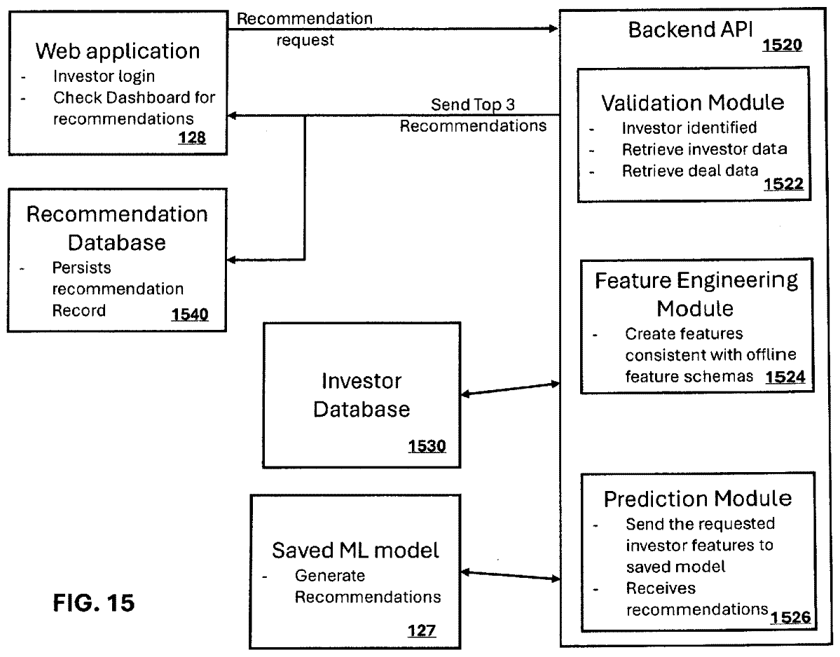

FIG. 15 illustrates an example of a synchronous, real-time method 1500 for serving personalized investment recommendations to a client application, in accordance with some embodiments. In this embodiment, a saved machine learning model is applied to live investor data through an API-orchestrated backend to generate, deliver, and persist investment recommendations while enabling auditability and future learning.

During the online phase, a web application 128 initiates a recommendation request when an investor logs into the application and accesses a dashboard displaying personalized recommendations. The web application 1510 transmits a recommendation request to a backend API 1520. In some embodiments, the request includes an investor identifier associated with the logged-in user.

Upon receiving the recommendation request, the backend API 1520 executes a validation module 1522. The validation module 1522 identifies the investor and retrieves corresponding investor profile information from an investor database 1530. In some embodiments, the validation module 1522 further retrieves relevant deal data required for recommendation generation and confirms that the investor is eligible to receive recommendations.

Following validation, the backend API 1520 invokes a feature engineering module 1524. The feature engineering module 1524 generates a set of investor features that are consistent with feature schemas used during offline model training. In some embodiments, this includes transforming, normalizing, and encoding investor attributes to produce a model-ready feature representation suitable for inference by the saved machine learning model.

After feature engineering, the backend API 1520 executes a prediction module 1526. The prediction module 1526 sends the engineered investor feature set to a saved machine learning model 127. The saved machine learning model 127 generates a ranked list of personalized investment recommendations based on the provided investor features and returns the recommendation results to the prediction module within the backend API 1520.

Upon receiving the recommendation results, the backend API 1520 performs a split output operation. In one path, the backend API 1520 transmits a subset of the ranked recommendations, such as a top-N list, to the web application 128 for presentation to the investor. In the web application 128, the recommendations are displayed on the investor's dashboard for review and interaction.

Concurrently, the backend API 1520 persists the generated recommendation set to a recommendation database 1540. In some embodiments, the persisted recommendation record includes the investor identifier, recommended deal identifiers, ranking positions, scores, timestamps, and an identifier of the saved machine learning model version used to generate the recommendations. This persistence enables traceability, auditability, and downstream analysis.

In some embodiments, the stored recommendation records are used to generate interaction logs when the investor subsequently views, clicks, or invests in recommended deals. These interaction logs provide feedback data that may be used in future offline training cycles, thereby enabling a self-improving recommendation system.

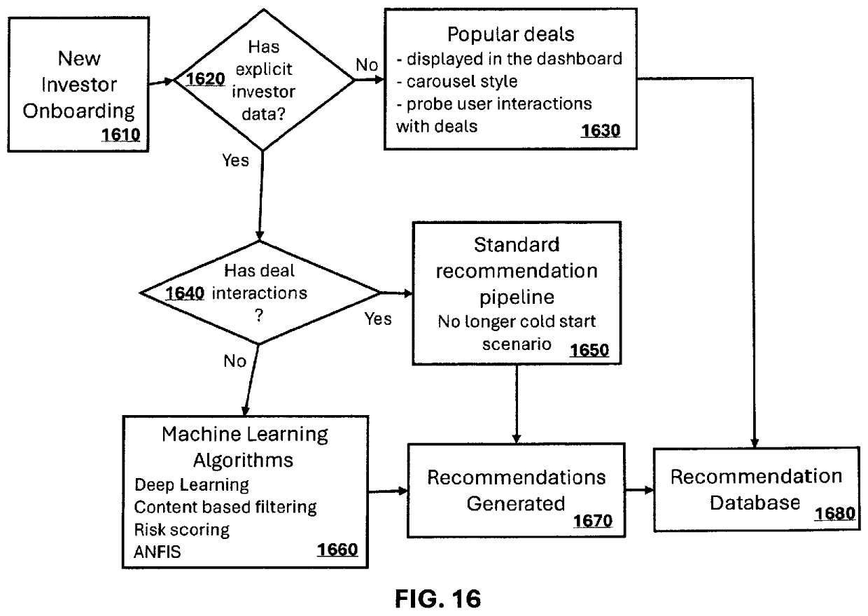

FIG. 16 illustrates an example of a cold-start decision and recommendation generation flow 1600, in accordance with some embodiments. The system determines whether a new investor has explicit profile data and interaction history, displays popular deals when no personalization data exists, applies machine learning models when explicit data is available, and transitions the investor out of the cold-start state once interaction history is established.

The process begins with new investor onboarding 1610, during which an investor is registered in the system without prior behavioral interaction history. Upon onboarding, the system evaluates the availability of investor information to determine an appropriate recommendation strategy.

The system first determines whether explicit investor data is available 1620. Explicit investor data may include stated investment objectives, risk tolerance, liquidity preferences, sector interests, or other declarative profile attributes collected during onboarding. If explicit investor data is not available, the system classifies the investor as a hard cold-start user. In this scenario, the system presents popular deals 1630 on the investor dashboard. In some embodiments, the popular deals are displayed in a carousel or similar presentation format and are selected based on overall engagement, participation, or momentum metrics across the platform. These popular deals are used to probe initial user interactions with deals and to collect early behavioral signals.

If explicit investor data is available, the system next evaluates whether the investor has deal interaction history 1640, such as prior views, clicks, or investments. If deal interaction history exists, the investor is no longer considered a cold-start user. The system transitions the investor to a standard recommendation pipeline 1650 that leverages behavioral and preference-based modeling.

If explicit investor data exists but no deal interaction history is available, the investor is classified as a soft cold-start user. In this case, the system invokes one or more machine learning algorithms 1660 (as described above) to generate personalized recommendations. In some embodiments, these algorithms include deep learning models 1132, content-based filtering 1136, risk scoring models 1134, and an Adaptive Neuro-Fuzzy Inference System (ANFIS) 1150 and others. These models operate on the explicit investor data to generate recommendations aligned with the investor's stated objectives and risk profile. Collaborative filtering is not used due to insufficient data.

Following model execution, deals aligned with the stated investor objectives are generated. The resulting recommendations 1670 may then be persisted to a recommendation database 1680 (i.e., one of database(s) 112), where they may be stored together with associated metadata such as investor identifiers, ranking information, and timestamps. The stored recommendations enable auditability and support future learning as additional interaction data becomes available.

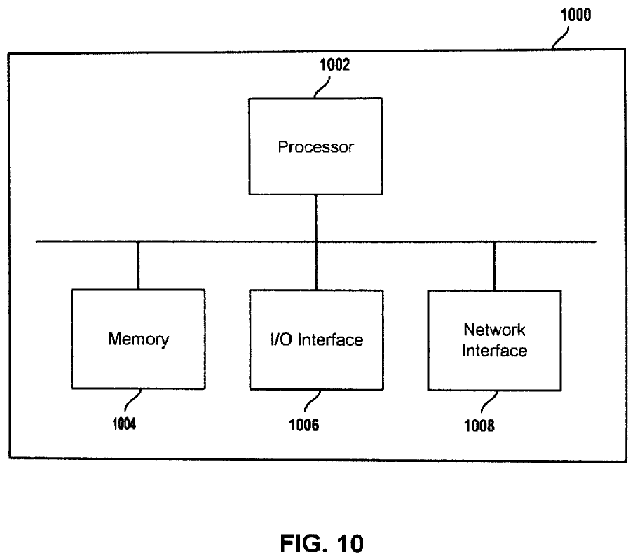

FIG. 10 is a schematic diagram of a computing device 1000 such as a server or other computer. As depicted, the computing device includes at least one processor 1002, memory 1004, at least one I/O interface 1006, and at least one network interface 1008.

Processor 1002 may be an Intel or AMD x86 or x64, PowerPC, ARM processor, or the like. Memory 1004 may include a suitable combination of computer memory that is located either internally or externally such as, for example, random-access memory (RAM), read-only memory (ROM), compact disc read-only memory (CDROM).

Each I/O interface 1006 enables computing device 1000 to interconnect with one or more input devices, such as a keyboard, mouse, camera, touch screen and a microphone, or with one or more output devices such as a display screen and a speaker.

Each network interface 1008 enables computing device 1000 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The foregoing discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A system for recommending deals, the system comprising:
a machine learning data model;
a database for storing feature values used by the machine learning data model, the database having placeholders for:
a plurality of investor feature categories;
a plurality of deal feature categories;
a plurality of investor scores; and
a plurality of deal scores;
at least one processor; and
a memory storing instructions which when executed by the at the least one processor cause the at least one processor to:
obtain investor data for a plurality of investors, the investor data based on a plurality of investor features;
obtain deal data for a plurality of deals, the deal data based on a plurality of deal features;
normalize the investor data into investor feature values, wherein investor constraints are factored into the investor feature values;
normalize the deal data into deal feature value, wherein deal constraints are factored into the deal feature values;
populate the investor feature values and the deal feature values into the database;
train the machine learning model with the investor feature values and the deal feature values, wherein the machine learning data model is configured to:
receive available normalized investor feature data into corresponding investor feature categories in the machine learning model;
receive available normalized deal feature data into corresponding deal feature categories in the machine learning model;
determine an overall investor score for each investor in the plurality of investors, each overall investor score determined using at least one of a plurality of investor score determination methods based on a subset of the available normalized investor feature data, each overall investor score stored in the database;
determine an overall deal score for each deal in the plurality of deals, each overall deal score determined using at least one of a plurality of deal score determination methods based on a subset of the available normalized deal feature data, each overall deal score stored in the database; and
determine a plurality of recommended deals for each investor based on the overall investor scores and the overall deal scores; and
send a notification message to each investor once the recommended deals have been determined for that investor.

2. The system as claimed in claim 1, wherein:
the machine learning data model is configured to:
update, in near real-time, the normalized investor data for a particular investor when a change in investor data is received for that particular investor;
update, in near real-time, the normalized deal data for a particular deal when a change in deal data is received for that particular deal;
update, in near real-time, the overall investor score for the particular investor responsive to an update to the normalized investor data for that particular investor;
update, in near real-time, the overall deal score for a particular deal responsive to an update to the normalized deal data for that particular deal;
update, in near real-time, the determination of the recommended deals for that particular investor responsive to an update to at least one of:
the overall investor score for that particular investor; or
the overall deal score for any deal in the plurality of deals; and
the at least one processor is configured to:
receive updates in at least one of investor data or deal data; and
send an update notification to the particular investor based on any change in the recommended deals for that particular investor.

3. The system as claimed in claim 2, wherein the at least one processor is configured to retrain the machine learning data model based on the changes to the investor feature values or deal feature values.

4. The system as claimed in claim 1, wherein the at least one processor is configured to automatically initiate a transaction for any deal recommended to a particular investor when the overall deal score for a recommended deal is within a threshold deviation from the overall investor score for that particular investor.

5. The system as claimed in claim 1, wherein the system comprises a two-tower deep retrieval module comprising:
a first-tower neural network that encodes investor attributes to generate embedding eᵤ; and
a second-tower neural network that encodes deal attributes to generate embedding e_{d};
wherein a relevance score is determined from the dot product of the embeddings S_{DL}(u,d)=eᵤ·e_{d}.

6. The system as claimed in claim 1, wherein to recommend at least three deals to an investor, the at least one processor is configured to:
cluster deals based on their overall deal risk scores; and
select the top at least three deals having overall deal scores that are closest in value to the overall investor risk score for that investor.

7. The system as claimed in claim 6, wherein to match investors to deals, the at least one processor is configured to:
determine a cosine similarity between investor profiles and available deals;
score each deal based on its similarity to an investor profile;
determine a top score subset of deals to each investor; and
recommend an overlap of results from the match based on the investor's risk score and the top score subset.

8. The system as claimed in claim 7, wherein the cosine similarity between client profiles and available transactions comprises:
$$cosine similarity = SC ( A , B ) : = cos ( θ ) = \frac{A \cdot B}{‖ A ‖ ‖ B ‖} = \frac{{Σ}_{i = 1}^{n} {A}_{i} {B}_{i}}{\sqrt{{Σ}_{i = 1}^{n} {A}_{i}^{2}} \cdot \sqrt{{Σ}_{i = 1}^{n} {B}_{i}^{2}}} .$$

9. The system as claimed in claim 1, wherein the client profile is created based on their previous investment activities.

10. The system as claimed in claim 1, wherein to match clients to transactions, the at least one processor is configured to:
generate client interaction matrices based fore each client on each client's past interaction information;
perform matrix factorization on each client latent feature matrix and each transaction latent feature matrix;
determine a dot product of each transaction latent feature matrix with a client latent feature matrix; and
recommend a top score subset of transactions to the client based on the dot product determinations.

11. A computer-implemented method of recommending transactions, the method comprising:
obtaining, by at least one processor, investor data for a plurality of investors, the investor data based on a plurality of investor features;
obtaining, by the at least one processor, deal data for a plurality of deals, the deal data based on a plurality of deal features;
normalizing, by the at least one processor, the investor data, wherein investor constraints are factored into the normalized investor data;
normalizing, by the at least one processor, the deal data, wherein deal constraints are factored into the normalized deal data;
populating, by the at least one processor, the normalized investor data and the normalized deal data into a database;
training, by the at least one processor, a machine-learning model with available normalized investor feature data and available normalized deal feature data into corresponding deal feature categories in the machine-learning data model;
determining, by the machine learning model, an overall investor risk score for each investor in the plurality of investors, each overall investor risk score determined using at least one of a plurality of investor risk determination methods based on a subset of the available normalized investor feature data, each overall investor risk score stored in the machine-learning data model;
determining, by the machine learning model, an overall deal risk score for each deal in the plurality of deals, each overall deal risks score determined using at least one of a plurality of deal risk determination methods based on a subset of the available normalized deal feature data, each overall deal risk score stored in the machine-learning data model;
determining, by the machine learning model, a recommendation of at least three deals for each investor based on the investor risk scores and the deal risk scores; and
sending, by the at least one processor, a notification message to each investor once the at least three deals have been determined for that investor.

12. The computer-implemented method as claimed in claim 11, comprising:
receiving, by the at least one processor, changes in at least one of investor data or deal data;
updating, in near real-time by the machine-learning data model, the normalized investor data for a particular investor when a change in investor data is received for that particular investor;
updating, in near real-time by the machine-learning data model, the normalized deal data for a particular deal when a change in deal data is received for that particular deal;
updating, in near real-time by the machine-learning data model, the overall investor risk score for the particular investor responsive to an update to the normalized investor data for that particular investor;
updating, in near real-time by the machine-learning data model, the overall deal risk score for a particular deal responsive to an update to the normalized deal data for that particular deal;
updating, in near real-time by the machine-learning data model, the determination of the recommendation for that particular investor responsive to an update to at least one of:
the overall investor risk score for that particular investor; or
the overall deal risk score for any deal in the plurality of deals; and
sending, by the at least one processor, an update notification to the particular investor based on any change in the recommendation for that particular investor.

13. The computer-implemented method as claimed in claim 11, wherein the at least one processor is configured to automatically initiate a transaction for any deal recommended to a particular investor when the overall deal score for a recommended deal is within a threshold deviation from the overall investor risk score for that particular investor.

14. The computer-implemented method as claimed in claim 11, comprises automatically initiating a transaction for any deal recommended to a particular investor when the overall deal score for a recommended deal is within a threshold deviation from the overall investor score for that particular investor.

15. The computer-implemented method as claimed in claim 11, comprising:
encoding, by a first-tower neural network, investor attribute to generate embedding eᵤ; and
encoding, by a second-tower neural network, deal attributes to generate embedding e_{d};
determining a relevance score from the dot product of the embeddings S_{DL}(u,d)=eᵤ·e_{d}.

16. The computer-implemented method as claimed in claim 11, wherein to recommend at least three deals to an investor, the computer-implemented method comprises:
clustering deals based on their overall deal risk scores; and
selecting the top at least three deals having overall deal scores that are closest in value to the overall investor risk score for that investor.

17. The computer-implemented method as claimed in claim 16, wherein to match investors to deals, the computer-implemented method comprises:
determining a cosine similarity between investor profiles and available deals;
scoring each deal based on its similarity to an investor profile;
determining a top score subset of deals to each investor; and
recommending an overlap of results from the match based on the investor's risk score and the top score subset.

18. The computer-implemented method as claimed in claim 17, wherein the cosine similarity between investor profiles and available deals comprises:
$$cosine similarity = SC ( A , B ) : = cos ( θ ) = \frac{A \cdot B}{‖ A ‖ ‖ B ‖} = \frac{{Σ}_{i = 1}^{n} {A}_{i} {B}_{i}}{\sqrt{{Σ}_{i = 1}^{n} {A}_{i}^{2}} \cdot \sqrt{{Σ}_{i = 1}^{n} {B}_{i}^{2}}} .$$

19. The computer-implemented method as claimed in claim 1, wherein the investor profile is created based on their previous investment activities.

20. The computer-implemented method as claimed in claim 11, wherein matching clients to transactions comprises:
generating client interaction matrices based fore each client on each client's past interaction information;
performing matrix factorization on each client latent feature matrix and each transaction latent feature matrix;
determining a dot product of each transaction latent feature matrix with a client latent feature matrix; and
recommending a top score subset of transactions to the client based on the dot product determinations.
